(19) United States
(12) Patent Application Publication
(10) Pub. No.: US 2005/0243362 A1
(43) Pub. Date: Nov. 3, 2005

(54) Image supplying apparatus, direct output system, and image output method

(75) Inventors: Kenji Sakuda, Nagano (JP); Hideki Morozumi, Nagano (JP); Yoshinao Kitahara, Nagano (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/050,451

(22) Filed: Feb. 4, 2005

(30) Foreign Application Priority Data
Feb. 4, 2004 (JP) P2004-028190

(51) Int. Cl. G06F 15/00

(52) U.S. Cl. 358/1.15

(57) ABSTRACT

A monitor receives an image data file and monitors whether an image output apparatus which outputs an image on the basis of the image data file is communicable with a communicator. A communication connector connects the communicator to an image output apparatus when the monitor determines that the image output apparatus is communicable with the communicator. An output starter transmits an output command to the image output apparatus after completion of the connection with the image output apparatus, to thus cause the image output apparatus to output an image.

### BACKGROUND OF THE INVENTION

The present invention relates to an image supplying apparatus for outputting, from an mage output apparatus, an image based on an image data file stored in the image supplying device or a storage, as well as to a direct output system and an image output method.

Japanese Patent Publication No. 10-173833A discloses a system that connects a camera to a printer by an infrared ray. In this system, print data conversion software is transmitted from the printer to the camera, and the camera is caused to execute the print data conversion software. Print quality is selected by a user interface generated as a result of execution of the software, thereby causing the printer to perform printing operation of desired quality.

Japanese Patent Publication No. 2003-259274A discloses a system where a digital camera, which is a USB storage class device, is connected directly to a printer, which is an USB host, by an USB (Universal Serial Bus). In this system, the camera generates, in the form of a file, a print status request, a print request, or a print abort request to the printer in accordance with operation of a button of the camera, and writes the file into internal memory of the camera. After having established a communication connection with the camera, the printer periodically checks the internal memory of the camera at a high-speed rate. When having found a requested file, the printer reads the file and executes the requested operation.

As mentioned above, in the system disclosed in Japanese Patent Publication No. 10-173833A, causing a printer to print images stored in a camera requires transmission of the print data conversion software from the printer to the camera, causing the camera to execute the print data conversion software, and selection of print quality by a user interface formed by execution of the print data conversion software.

In the system disclosed in Japanese Patent Publication No. 2003-259274A, in order to cause a printer to print images stored in a camera, the user must generate a print status request or a print request to the printer by operating a button of the camera, and cause the printer to acquire the request.

Therefore, in the conventional system, in order to cause the printer to print images stored in the camera, the user must perform operation for acquiring software or setting printing conditions after having physically connected the camera to the printer.

A round of operations required to cause the printer to print the images stored in the camera cannot be said to be simple. Moreover, these operations must be performed every time the user attempts to cause the printer to output the images stored in the camera. For this reason, some of the users feel burdened by the round of operations required to cause the printer to print the images stored in the camera.

### SUMMARY OF THE INVENTION

It is therefore an object of the invention to provide an image supplying apparatus, a direct output system, and an image output method, which obviate a necessity for causing a user to perform complicate operation every time an image based on an image data file stored in the image supplying apparatus or a storage is output to the image output apparatus.

In order to achieve the above object, according to the invention, there is provided an image supplying apparatus comprising:

a communicator;

a monitor, which receives an image data file and monitors whether or not an image output apparatus which outputs an image on the basis of the image data file is communicable with the communicator;

a communication connector, which connects the communicator to an image output apparatus when the monitor determines that the image output apparatus is communicable with the communicator; and

an output starter, which transmits an output command to the image output apparatus after completion of the connection with the image output apparatus, to thus cause the image output apparatus to output an image.

By this configuration, the image output apparatus is automatically connected to the image supplying apparatus. Subsequently, output of an image is commenced. Therefore, the user does not need to perform operation for causing the image supplying apparatus or the image output apparatus to output an image. Consequently, the user does not have to perform complicate operation every time an image of the image data stored in the image supplying apparatus is output to the image output apparatus.

Preferably, the output starter generates an output command in accordance with a preset output condition and transmits the thus-generated output command to the image output apparatus.

By this configuration, it is possible to cause the image output apparatus to execute an output in accordance with the preset output condition. Consequently, the user does not have to set an output condition every time the image output is executed. Even in this situation, it is possible to cause the image output apparatus to execute a desired image output.

Preferably, the output starter generates the output command immediately after the completion of the connection in a case where a setting allowing an automatic output is effected in advance, and transmits the output command to the image output apparatus.

By this configuration, execution of automatic output can be controlled by setting necessity or unnecessity for automatic output in advance. Specifically, the setting is effected so as not to allow automatic output, thereby preventing the image output apparatus from arbitrarily producing an unnecessary output. Moreover, when setting is effected to allow automatic output, the image output apparatus can automatically produce an output.

Preferably, the output starter generates an output command only when the output starter is connected to an image output apparatus specified in advance, and transmits the output command to the image output apparatus.

By this configuration, the execution of the automatic output can be managed by specifying in advance an image output apparatus which executes the automatic output. Namely, an image output apparatus other than the image output apparatus for which setting has been effected in advance can be prevented from producing an unnecessary output. Moreover, the image output apparatus specified in advance can automatically execute an output.

Preferably, the output starter makes an inquiry about whether an automatic output is required when the connection to the image output apparatus is completed. When allowance of automatic output is instructed, an output command is generated, and the output command is transmitted to the image output apparatus.

By this configuration, execution of automatic output can be controlled by instructing an inquiry about a necessity or unnecessity for automatic output, whereby execution of automatic output can be controlled. As a result, even when connection to the image output apparatus is automatically established, the image output apparatus can be prevented from automatically producing an output. Moreover, the image output apparatus can be caused to automatically produce an output by only allowing automatic output.

Preferably, the image supplying apparatus further comprises a recording medium storing an image data file. The output starter generates an output command which specifies all of image data files not having been used for outputting images among the image data files in the recording medium, and transmits the output command to the image output apparatus.

By this configuration, only the image data files not having been used for producing image outputs are automatically specified as objects of image output, and the images can be outputted. As a result, an image based on the same image data can be prevented from being output twice.

Preferably, the output starter informs the user of at least one of: that the connection to the image output apparatus is being automatically performed; that the connection to the image output apparatus has been automatically performed; that image output is being automatically performed; and that image output has been automatically performed.

By this configuration, the user can ascertain an extent to which operation that is being automatically performed has been completed, on the basis of the report from the output starter.

According to the invention, there is also provided an image supplying apparatus comprising:

a slot, into which a storage storing an image data file is removably inserted;

a communicator, adapted to communicate with a communicator of an image output apparatus which receives the image data file and outputs an image on the basis of the image data file; and

an output starter, which transmits an output command to the image output apparatus when the storage is inserted into the slot and causes the image output apparatus to start outputting an image on the basis of the image data file stored in the storage.

By this configuration, when the storage is inserted into the image supplying apparatus, output of an image is automatically commenced. Consequently, the user does not need to perform operation for causing the image supplying apparatus or the image output apparatus to produce an output. As a consequence, the user does not have to perform complicate operation every time the images of the image data stored in the storage are output to the image output apparatus.

According to the invention, there is also provided a direct output system, comprising an image output apparatus provided with a communicator adapted to be connected the communicator of the above image supplying apparatus.

By this configuration, the image output apparatus and the image supplying apparatus are automatically connected together, and image output is subsequently commenced. Therefore, the user does not need to perform operation for causing the image output apparatus or the image supplying apparatus to produce an output. As a consequence, the user does not have to perform complicate operation every time the images of the image data stored in the image supplying apparatus or the storage are output to the image output apparatus.

According to the invention, there is also provided an image output method, comprising:

monitoring whether or not an image output apparatus is connectable with an image supplying apparatus which supplies an image data file;

connecting the image supplying apparatus and the image output apparatus when the image output apparatus and the image supplying apparatus are communicable with each other; and

transmitting an output command from the image supplying apparatus to the image output apparatus after completion of the connecting, thereby causing the image output apparatus to start producing an image output.

By this configuration, the image supplying apparatus and the image output apparatus are automatically connected together, and the image output apparatus starts image output. Therefore, the user does not need to perform operation for causing the image output apparatus or the image supplying apparatus to produce an output. As a consequence, the user does not have to perform complicate operation every time the images of the image data stored in the image supplying apparatus are output to the image output apparatus.

### BRIEF DESCRIPTION OF THE DRAWINGS

In the accompanying drawings,

FIG. 1 is a block diagram showing a direct printing system according to a first embodiment of the present invention;

FIG. 2 is a block diagram showing the hardware configuration of a digital still camera of FIG. 1;

FIG. 3 is a view showing stored contents of a flash memory of FIG. 2;

FIG. 4 is a view showing stored contents of a removable memory of FIG. 2;

FIG. 5 is a block diagram showing the hardware configuration of a printer of FIG. 1;

FIG. 6 is a view showing stored contents of a memory of FIG. 5;

FIG. 7 is a view showing a stacked structure of a communication protocol for direct printing realized by the direct printing system of FIG. 1;

FIG. 8 is a view showing a direct print processing sequence to be executed between the digital still camera and the printer, both of which are shown in FIG. 1;

FIG. 9 is a view showing an example start print request generated by a print client;

FIG. 10 is a view showing stored contents of flash memory of a digital still camera according to a second embodiment of the present invention;

FIG. 11 is a view showing a stacked structure of a communication protocol for direct printing to be realized by a direct printing system according to the second embodiment;

FIG. 12 is a view showing a direct print processing sequence to be executed between the digital still camera and the printer, both of which are shown in FIG. 11;

FIG. 13 is a view showing stored contents of a flash memory of a digital still camera according to a third embodiment of the present invention;

FIG. 14 is a view showing a stacked structure of a communication protocol for direct printing to be realized by a direct printing system according to the third embodiment;

FIG. 15 is a view showing a direct print processing sequence to be executed between the digital still camera and the printer, both of which are shown in FIG. 14;

FIG. 16 is a view showing stored contents of a flash memory of a digital still camera according to a fourth embodiment of the present invention;

FIG. 17 is a view showing a stacked structure of a communication protocol for direct printing to be realized by a direct printing system according to the fourth embodiment;

FIG. 18 is a view showing a direct print processing sequence to be executed between the digital still camera and the printer, both of which are shown in FIG. 17;

FIG. 19 is a view showing stored contents of a flash memory of a digital still camera according to a fifth embodiment of the present invention;

FIG. 20 is a view showing stored contents of a memory of a printer according to the fifth embodiment of the present invention;

FIG. 21 is a view showing a stacked structure of a communication protocol for direct printing to be realized by a direct printing system according to the fifth embodiment;

FIG. 22 is a view showing a direct print processing sequence to be executed between the digital still camera and the printer, both of which are shown in FIG. 21;

FIG. 23 is a view showing stored contents of a flash memory of a digital still camera according to the second embodiment of the present invention;

FIG. 24 is a view showing stored contents of a flash memory of a digital still camera according to the second embodiment of the present invention;

FIG. 25 is a view showing a stacked structure of a communication protocol for direct printing to be realized by a direct printing system according to a sixth embodiment;

FIG. 26 is a view showing a direct print processing sequence to be executed between the digital still camera and the printer, both of which are shown in FIG. 25;

FIG. 27 is a block diagram showing a direct printing system according to a seventh embodiment of the present invention;

FIG. 28 is a block diagram showing the hardware configuration of a digital still camera of FIG. 27;

FIG. 29 is a view showing stored contents of a flash memory of FIG. 28;

FIG. 30 is a view showing stacked structure of a communication protocol for direct printing realized by a direct printing system of FIG. 27; and

FIG. 31 is a view showing a direct print processing sequence to be executed between a digital still camera and the printer, both of which are shown in FIG. 30.

### DETAILED DESCRIPTION OF THE INVENTION

An image supplying apparatus, a direct output system, and an image output method, all pertaining to embodiments of the present invention, will be described hereunder by reference to the accompanying drawings. The direct output system will be described by taking a direct printing system as an example. The image supplying apparatus will be described by taking a digital still camera or a card reader as an example. An output method will be described as a part of a printing method for use with a direct printing system.

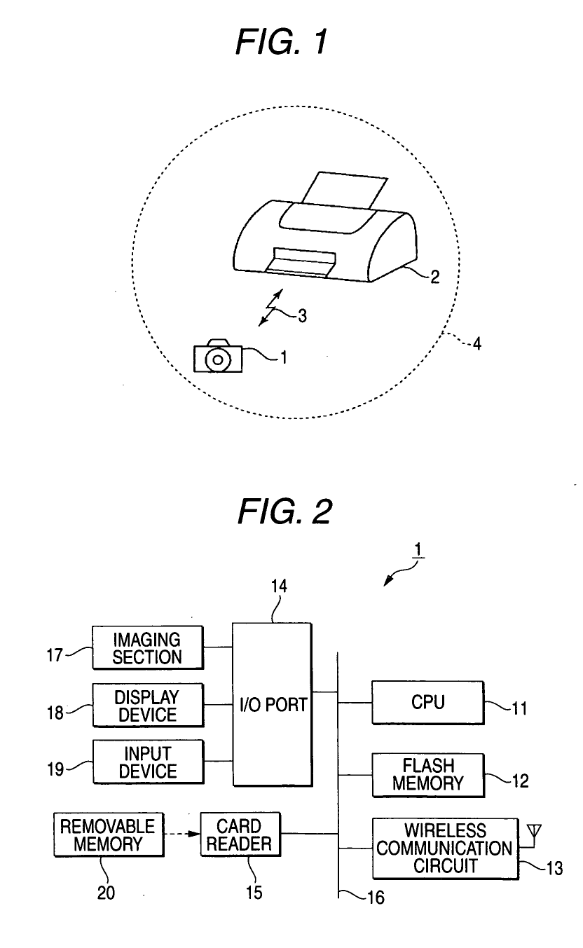

FIG. 1 is a block diagram showing a direct printing system according to a first embodiment of the present invention. The direct printing system comprises a digital still camera (DSC) 1 which is to serve as an image supplying apparatus and a printer 2 which is to serve as an image output apparatus. The DSC 1 and the printer 2 are connected together by a wireless network 3 realized by wireless communication.

The wireless network 3 is, for example, a wireless network based on IEEE (the Institute of Electrical and Electronic Engineers) 802.11 or a close-zone wireless communication network such as Bluetooth. Moreover, unlike the wireless network based on IEEE or the short-zone wireless communication network, the wireless network 3 may use infrared rays rather than radio waves. The wireless network 3 may have an access restriction function involving preliminary registration, such as a MAC address, or an anti-tapping function using WEP (Wired Equivalent Privacy). Incidentally, the wireless network 3 is realized as a result of presence of the DSC 1 in a wireless connection zone 4 of the printer 2. Put another way, the network is realized as a result of the printer 2 being present within the wireless connection zone 4 of the DSC 1. More specifically, communication between the DSC 1 and the printer 2 becomes possible as a result of either the DSC 1 entering the wireless connection zone of the printer 2 or the printer 2 entering the wireless connection zone of the DSC 1.

FIG. 2 is a block diagram showing the hardware configuration of the DSC 1 in FIG. 1. The DSC 1 comprises a Central Processing Unit (CPU) 11 which executes a program; a flash memory 12; a wireless communication circuit 13 which is to serve as a communicator connected to the wireless network 3; an I/O (Input/Output) port 14; a card reader 15; and a bus 16 for interconnecting these elements. An imaging section 17 which produces image data by imaging action, a display device 18 for displaying various data or images, and an input device 19 for producing input data in accordance with an operation are connected to the I/O port 14. A removable memory 20 which is formed from semiconductor memory or the like and acts as a storage or a recording medium is removably inserted into the card reader 15.

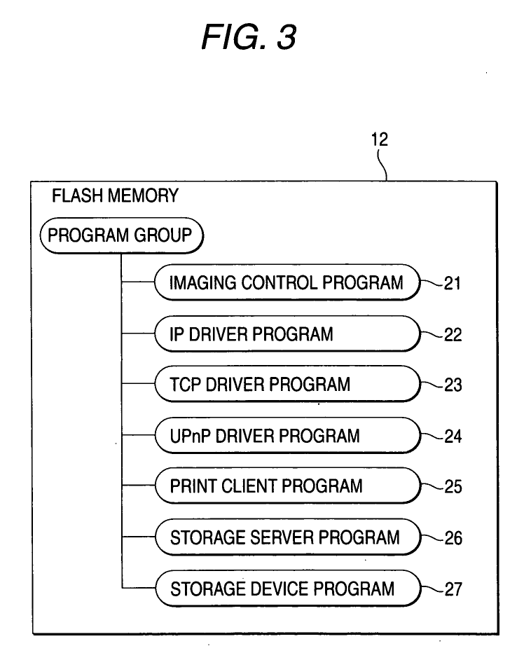

FIG. 3 is a view showing stored contents of the flash memory 12 shown in FIG. 2. A program group is stored in the flash memory 12. The program group of the flash memory 12 includes an imaging control program 21, an IP (Internet Protocol) driver program 22, a TCP (Transmission Control Protocol) driver program 23, a UPnP (Universal Plug and Play) driver program 24, a print client program 25, a storage server program 26, and a storage device program 27.

The imaging control program 21 is executed by the central processing unit 11, thereby embodying an imaging control section. This imaging control section controls the imaging section 17. The image data captured by the imaging section 17 is stored in the removable memory 20 as image data files of a JPEG (Joint Photographic Expert Group) scheme, an EXIF (Exchangeable Image File Format) scheme, or the like.

The IP driver program 22 is executed by the central processing unit 11, thereby embodying an IP driver. The Internet protocol uses an IP address. This IP address is an address uniquely assigned within at least the wireless network 3 on a per-device basis. The IP address also includes a broadcast address. The IP driver exchanges transmission data with another IP driver using the IP address.

The TCP driver program 23 is executed by the central processing unit 11, thereby implementing a TCP driver. This TCP driver ensures connection with another TCP driver and manages a communication channel.

The UPnP driver program 24 is executed by the central processing unit 11, to thus implement a UPnP driver which is to serve as monitor. The UPnP driver performs automatic assignment of an IP address, name solution, and detection of a device.

The print client program 25 is executed by the central processing unit 11, thereby realizing a print client which exchanges a request or response pertaining to control of a progress in printing operation or to printing operation.

The storage server program 26 is executed by the central processing unit 11, thereby realizing a storage server which exchanges a request or response pertaining to a storage operation.

The storage device program 27 is executed by the central processing unit 11, thereby realizing a storage device which performs operation for inputting or outputting data into or from a storage medium.

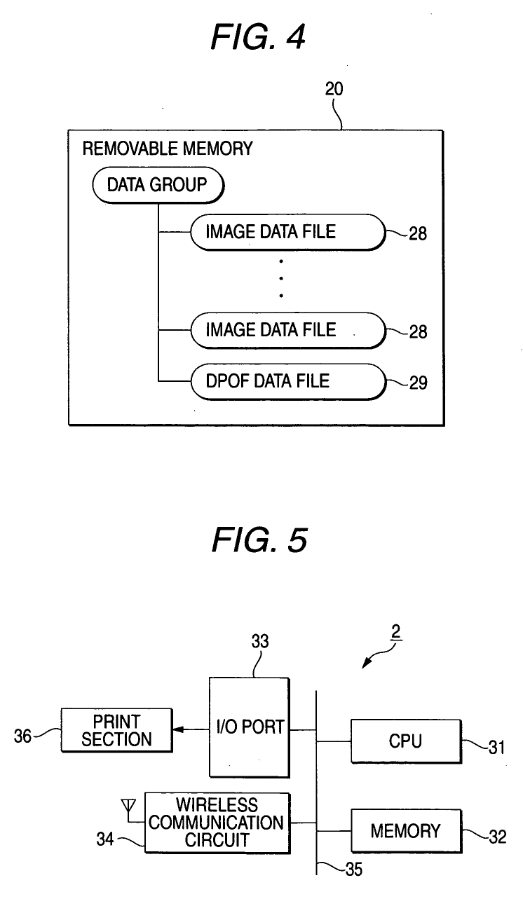

FIG. 4 is a view showing stored contents of the removable memory 20 shown in FIG. 2. A data group is stored in the removable memory 20. The data group in the removable memory 20 includes a plurality of image data files 28. Image data pertaining to one stationary image are stored in each of the image data files 28. In the DSC 1, the image data file 28 includes the image data generated by the imaging section 17. Each of the image data files 28 has a file name and a file ID (address), which are different from those of the other image data files.

The data group of the removable memory 20 may include a DPOF (Digital Print Order Format) data file 29. DPOF data are stored in the DPOF data file 29. The DPOF data are of format standardized for requesting a development-and-printing shop to print image data. By the DPOF data, it is possible to specify the file name of image data to be printed, the size of photographic paper to be subjected to printing, the print size of an image, the layout of an image, and the number of prints.

FIG. 5 is a block diagram showing the hardware configuration of the printer 2 shown in FIG. 1. The printer 2 comprises a central processing unit 31, a memory 32, an I/O port 33, a wireless communication circuit 34 which is to serve as a communicator and connected to the wireless network 3, and a bus 35 for interconnecting these elements. The I/O port 33 is connected to a print section 36 which subjects paper or an OHP sheet to printing in accordance with a predetermined printer code.

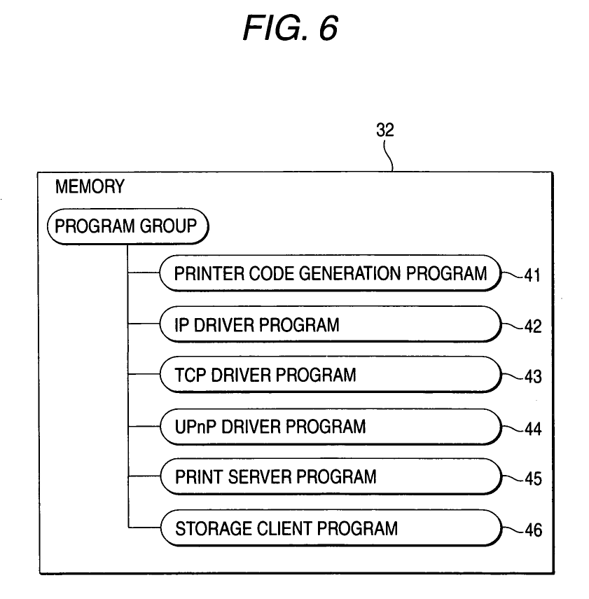

FIG. 6 is a view showing stored contents of the memory 32 shown in FIG. 5. A program group is stored in the memory 32. The program group of the memory 32 includes a printer code generation program 41, an IP driver program 42, a TCP driver program 43, a UPnP driver program 44, a print server program 45, and a storage client program 46.

The printer code generation program 41 is executed by the central processing unit 31, thereby realizing a printer code generator. The printer code generator generates a printer code; for example, an ESC/P (Epson Standard Code/Page) command, on the basis of image data and print setting information about the same. This printer code is output to the print section 36 by way of the I/O port 33.

The IP driver program 42 is executed by the central processing unit 31, thereby realizing an IP driver. The TCP driver 43 is executed by the central processing unit 31, thereby embodying a TCP driver. The UPnP driver program 44 is executed by the central processing unit 31, thereby realizing an UPnP driver.

The print server program 45 is executed by the central processing unit 31, thereby realizing a print server which exchanges a request or response pertaining to control of progress in printing operation or to printing operation.

The storage client program 46 is executed by the central processing unit 31, thereby realizing a storage client which exchanges a request or response pertaining to a storage operation.

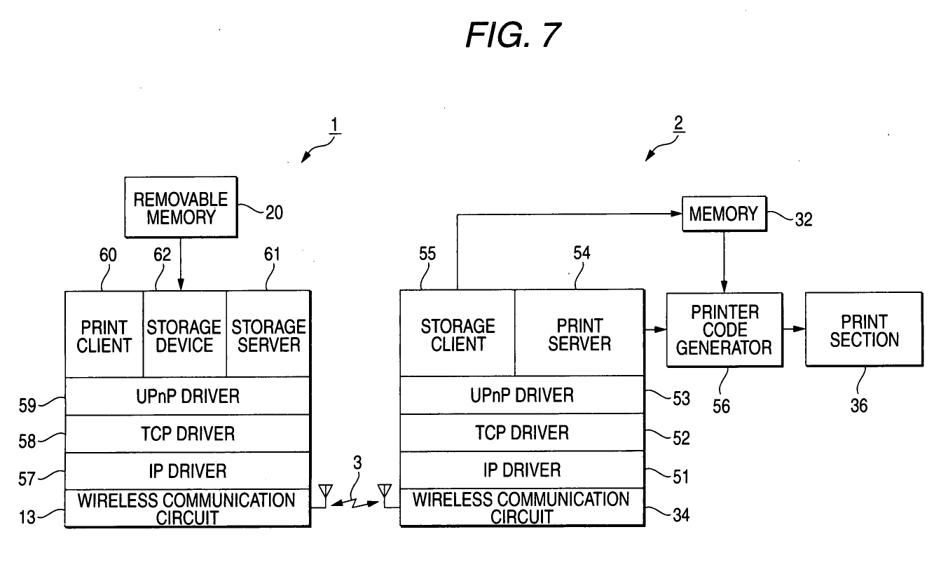

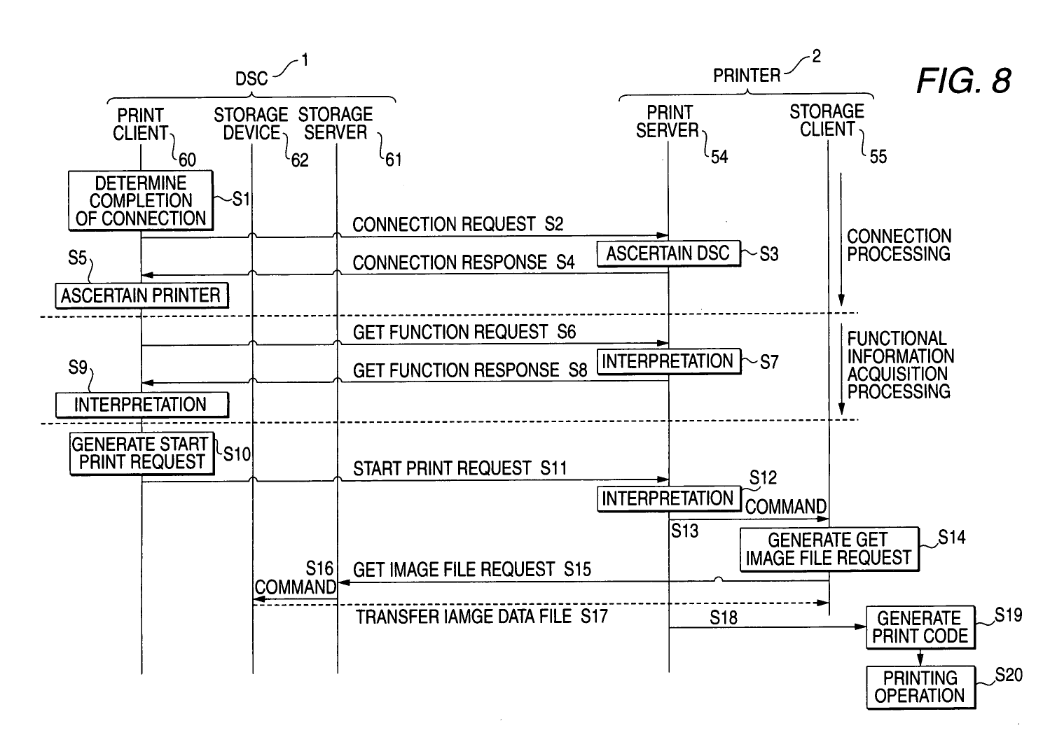

Next, operation of the direct printing system having the above-described configuration will be described. FIG. 7 is a view showing a stacked structure of a communication protocol for use in direct printing operation realized by the direct printing system shown in FIG. 1. FIG. 8 is a view showing a direct printing operation sequence performed between the DSC 1 and the printer 2.

In the printer 2, an IP driver 51, a TCP driver 52, and a UPnP driver 53 are ranked higher than the wireless communication circuit 34. A print server 54 and a storage client 55 are ranked higher than the UPnP driver 53. Moreover, a printer code generator 56 is realized in the printer 2.

No DHCP (Dynamic Host Configuration Protocol) server which assigns an IP address is present in the wireless network 3. Therefore, even when having sent a request for adding an IP address to the wireless network 3, the IP driver 51 of the printer 2 cannot acquire an IP address of its own as a response.

For this reason, a timeout arises in the DHCP server awaiting acquisition of an IP address. When the timeout has arisen, the UPnP driver 53 of the printer 2 selects one from a plurality of previously-assigned IP addresses. The UPnP driver 53 of the printer 2 causes the wireless communication circuit 34 to transmit a request for ascertaining whether or not the thus-selected IP address is being used. A broadcast address is specified as a destination of the request data.

For instance, in a case where the printer 2 has been started up prior to the DSC 1, the wireless communication circuit 34 of the printer 2 does not receive response data even when a predetermined time has lapsed since transmission of the request data. After a timeout has arisen, the UPnP driver 53 of the printer 2 specifies the selected IP address as its own IP address. Thus, the printer 2 is started up. The IP driver 51 of the printer 2 uses the thus-designated IP address as its own IP address. Subsequently, the printer 2 periodically attempts to detect another piece of connectable equipment (DSC 1) on the basis of UPnP.

In the meantime, when the DSC 1 has been started up, an IP driver 57, a TCP driver 58, and a UPnP driver 59, which is to serve as a communication connector, are embodied in levels which are higher than the wireless communication circuit 13 in the DSC 1. A print client 60, a storage server 61, and a storage device 62 are embodied as an output starter in levels which are higher than the UPnP driver 59.

When the power of the DSC 1 is turned on, operation for acquiring an IP address is initiated. However, a timeout also arises in the DSC 1 awaiting acquisition of the IP address of the DHCP server. Hence, the UPnP driver 59 of the DSC 1 selects one from the plurality of previously-assigned IP addresses, and transmits to the wireless communication circuit 13 request data to be used for ascertaining whether or not the selected IP address is being used.

When the DSC 1 is present within the wireless connection zone 4 of the printer 2, the request data transmitted to the wireless network 3 are received by the wireless communication circuit 34 of the printer 2. The wireless communication circuit 34 of the printer 2 outputs the request data to the UPnP driver 53 of the printer 2. The UPnP driver 53 of the printer 2 compares its own IP address with the IP address included in the request data. When a match is found, the UPnP driver 53 transmits the response data to the wireless communication circuit 34. The response data transmitted to the wireless network 3 are received by the wireless communication circuit 13 of the DSC 1.

When having received the response data, the wireless communication circuit 13 of the DSC 1 outputs the response data to the UPnP driver 59 of the DSC 1. When a timeout has arisen without the UPnP driver 59 of the DSC 1 receiving the response data, the UPnP driver 59 designates the selected IP address as its own IP address. The IP driver 57 of the DSC 1 uses the thus-designated IP address as its own IP address.

In the meantime, when having received the response data, the UPnP driver 59 again selects another IP address from the plurality of previously-assigned IP addresses, and transmits to the wireless communication circuit 13 request data to be used for ascertaining whether or not the newly selected IP address is being used.

Subsequently, the UPnP driver 59 of the DSC 1 repeats the operation for re-selecting an IP and operation for ascertaining whether or not the thus-selected IP address is being used, until an unoccupied IP address is found. Even when the printer 2 and the DSC 1 separately perform operation for selecting an IP address, occurrence of an overlap of a single IP address in the wireless network 3 can be prevented by the above-described control operation. When the DSC 1 does not exist within the wireless connection zone 4 of the printer 2 at start-up and then moves to the inside of the wireless connection zone 4 of the printer 2, the same IP address may be assigned to the DSC 1 and the printer 2. When the DSC 1 and the printer 2 are assigned the same IP address, any one of the IP addresses is changed to any other IP address during operation for connecting the DSC 1 to the printer 2 or when the DSC 1 is moved to the wireless connection zone 4.

The IP address of the DSC 1 and that of the printer 2 are determined as mentioned above. When the IP addresses have been determined, the UPnP driver 59 of the DSC 1 searches for another piece of connectable equipment compatible with UPnP. When another piece of connectable equipment is not found, the UPnP driver 59 of the DSC 1 periodically or continuously searches for such equipment. At this time, the UPnP driver 59 of the DSC 1 broadcasts a predetermined request within the network. On the basis of a response to the thus-broadcasted request, the UPnP driver 59 of the DSC 1 detects another piece of connectable equipment compatible with UPnP. Therefore, when the DSC 1 is present within the wireless connection zone 4 of the printer 4, the UPnP driver 53 of the printer 2 transmits a response to the request. As a result, the DSC 1 detects existence of the printer 2, and the printer 2 also detects the presence of the DSC 1. Communication based on TCP/IP becomes feasible between the DSC 1 and the printer 2. Upon detection of existence of the printer 2, the DSC 1 becomes able to establish the communication based on TCP/IP. For this reason, the DSC 1 determines that the operation for connection with the printer 2 has been completed (step S1) and immediately (i.e., automatically) commences direct printing operation without awaiting user's operation.

A determination as to completion of operation for connection with the printer 2 using a driver of lower-order protocol may be a determination based on establishment of a connection through TCP in addition to a determination based on decision of an IP address.

When the operation for connection with the printer 2 has been completed, the print client 60 of the DSC 1 and/or the print server 54 of the printer 2 perform(s) connection operation as initial processing of the direct printing operation. Specifically, for example, the print client 60 of the DSC 1 transmits a connection request for determining whether or not the printer 2 can perform direct printing which is identical in method with the direct printing performed by the DSC 1 (step S2). This connection request is described in the format of XML (eXtensible Markup Language) and handled as one text data file. Similarly, the request or response exchanged between the print client 50 and the print server 54 and that exchanged between the storage client 55 and the storage server 61 are described in XML.

The connection request generated by the print client 60 of the DSC 1 is converted into communication data of TCP standards by the TCP driver 58 of the DSC 1, and the thus-converted communication data are further converted into communication data of IP standards by the IP driver 57. The wireless communication circuit 13 of the DSC 1 transmits the communication data of IP standards to the wireless network 3. The destination of the communication data of the IP standards is an IP address of the preceding printer 2.

The wireless communication circuit 34 of the printer 2 connected to the wireless network 3 receives the communication data. The communication data received by the wireless communication circuit 34 are reversely converted into the communication data of TCP standards by the IP driver 51 of the printer 2, because the IP address of the destination of the received communication data is the IP address of the wireless communication circuit 34. Further, the thus-reversely-converted communication data are reversely converted into the connection request. The connection request generated through reverse conversion is passed to the print server 54 from the TCP driver 52. As a result, the connection request is transmitted from the print client 60 to the print server 54.

The printer server 54 interprets specifics of the thus-reversely-converted connection request (step S3). As a result, the print server 54 recognizes that a DSC 1 compatible with direct printing is connected to the printer 2.

The print server 54 generates a connection response which is described in an XML format and shows that direct printing which is identical in method with that performed by the DSC 1 can be performed. The connection response generated by the print server 54 of the printer 2 is converted into communication data of TCP standards by the TCP driver 52 of the printer 2. The communication data are further converted into communication data of IP standards by the IP driver 51. The thus-converted communication data are transmitted to the wireless communication circuit 13 of the DSC 1 from the wireless communication circuit 34 of the printer 2 by way of the wireless network 3, and the thus-transmitted communication data are reversely converted into communication data of TCP standards by the IP driver 57 of the DSC 1. The communication data are further reversely converted into the connection request by the TCP driver 58. The connection response generated through reverse conversion is passed to the print client 60 from the TCP driver 58 of the DSC 1. As a result, the connection response is transmitted from the print server 54 to the print client 60 (step S4). Further, the print client 60 interprets specifics of the thus-reversely-converted connection response and recognizes that the DSC 1 is connected to the printer 2 capable of performing direct printing which is identical in method with that performed by the print client 60 (step S5).

When connection operation is completed, the print client 60 of the DSC 1 initiates functional information acquisition operation. Specifically, for instance, the client 60 of the DSC 1 generates a get function request described in the XML format, and transmits the thus-generated get function request to the print server 54 of the printer 2 (step S6). The print server 54 interprets specifics of the get function request (step S7), and generates a get function response including information about printing capability of the print server.

The information about printing capability of the print server includes, e.g., version information compatible with the print server 54, the name of a vendor, information unique to the vendor, the model name of the printer 2, a model, a serial number, and the like. In addition to these, the information about printing capability of the print server includes a paper size which can be printed by the printer 2, print quality, the type of paper, the file type of handleable image data, printing/nonprinting of a photographed date (year, month, and day), printing/nonprinting of a file name, and the type of a printable layout.

The print server 54 of the printer 2 transmits the get function response to the print client 60 of the DSC 1 (step S8). The print client 60 of the DSC 1 interprets information about the printing capability of the printer 2 included in the get function response (step S9).

After such an operation for acquiring functional information has been completed, the print client 60 of the DSC 1 immediately and automatically generates a start print request (output command) for printing images of all of the image data files 28 preserved in the removable memory 20 on the basis of the thus-interpreted printing capability of the printer 2 (step S10).

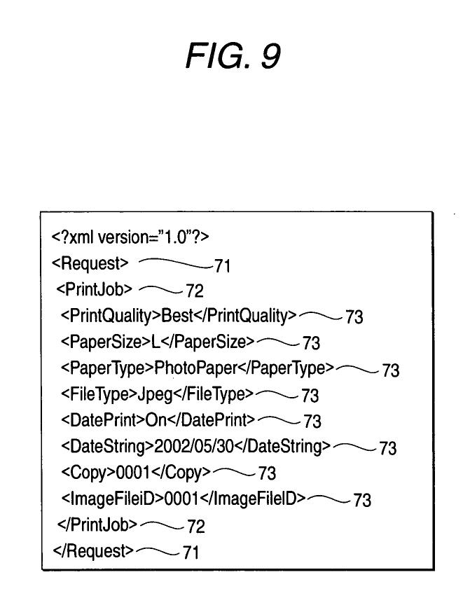

FIG. 9 is a view showing an example start print request generated by the print client 60. The start print request is a request described in the XML format and is handled as one text data file. A pair of tags 72 showing that the request pertains to a print job (printing operation) are described between a pair of tags 71 showing the request. Text data showing specifics of a print command are described between the pair of tags 72 showing a print job are described while being sandwiched between a pair of tags 73 respectively showing attributes of the text data.

The start print request shown in FIG. 9 is an exemplary case where one image data file 28 of JPEG format, whose file ID (an identification number assigned to a file name in a one-to-one correspondence) is 0001, is stored in the removable memory 20. In this case, production of one copy by printing the image data on L-size photo-paper, along with a date of May 30, 2002, in best quality is commanded as a print mode optimal for printing the image data.

When the DPOF data file 29 is stored in the removable memory 20, the print client 60 may specify the file name of the DPOF data file 29 in a prioritized manner in lieu of the file ID for the image data file 28 in response to the start print request.

The print client 60 of the DPS 1 transmits the start print request to the print server 54 of the printer 2 (step S11). The print server 54 interprets specifics of the print command of the start print request (step S12). The print server 54 commands the storage client 55 to acquire the image data file 28 required to perform the printing operation (step S13). The storage client 55 generates a get image file request for acquiring the image data file 28 from the DSC 1 (step S14). The storage client 55 transmits the get image file request to the storage server 61 of the DSC 1 (step S15). The storage server 61 of the DSC 1 commands the storage device 62 to transmit the image data file 28 required by the get image file request (step S16). The storage device 62 of the DSC 1 transmits to the printer 2 the image data file 28 instructed by the storage server 61 (step S17). The image data file 28.is stored in the memory 32 of the printer 2.

When the image data file 28 has been acquired by the memory 32, the print server 54 of the printer 2 commands the print code generator 56 to perform printing operation (step S18). In accordance with specifics of the print command of the start print request, the print code generator 56 generates a printer code for printing image data belonging to the image data file 28 stored in the memory 32 (step S19). The printer code is output to the print section 36 by way of the I/O port 33. The print section 36 performs printing operation in accordance with the printer code (step S20).

As a result, the printer 2 outputs a printed material complying with the specifics of the print command of the start print request. In the embodiment shown in FIG. 9, image data of JPEG format of a file ID 0001 stored in the removable memory 20 are printed on L-size photo-paper with best quality, to thus produce one copy.

In a case where the plurality of image data files 28 are stored in the removable memory 20 of the DSC 1 or where printing of the plurality of image data files 28 is instructed by the start print request designating the DPOF data file 29 in place of the file ID of the image data file 28, the print code generator 56 generates a printer code after having finished acquiring all of the image data files 28.

When generation of the printer code is not initiated until acquisition of all of the plurality of image data files 28 is completed as mentioned above, a certain amount of time is consumed before the print code generator 56 starts generating a printer code. Therefore, it is preferable for the print code generator 56 to sequentially generate a printer code immediately after completion of receipt of the image data to be printed on one piece of print paper; that is, a minimum unit of image data required to perform one printing operation. As a result, the wait time of the printer code generator 56 is curtailed, and a wait time which elapses before the printer 2 outputs a first printed material or a time which elapses before the printer 2 completes printing operation can be reduced. When the number of image data files 28 is large, index printing may be specified by the printer start request. Here, index printing is printing of images of a plurality of image data files in a scaled-down layout.

As mentioned above, in the first embodiment, the printer 2 and the DSC 1 are automatically connected together, and direct printing is automatically started. Therefore, the user does not need to perform operation for causing the DSC 1 or the printer 2 to perform direct printing. Consequently, the user is not required to perform complicate operation every time the printer is caused to print an image of the image data file 28 of the DSC1.

In the first embodiment, the print client 60 of the DSC 1 determines completion of the operation for connection with the printer 2, and automatically starts direct printing operation on the basis of determination. However, the print server 54 of the printer 2 may be arranged so as to determine completion of the operation for connection with the DSC 1 and request the DSC 1 to start direct printing, whereupon the DSC 1 starts direct printing operation in response to the request.

In the first embodiment, the print client 60 of the DSC 1 starts a direct printing operation sequence after completion of the operation for connection with the printer 2 based on a low-order protocol. In this case, a point in time when the operation for connection with the printer 2 is completed may be a point in time when the print client 60 completes connection processing or functional information acquisition operation.

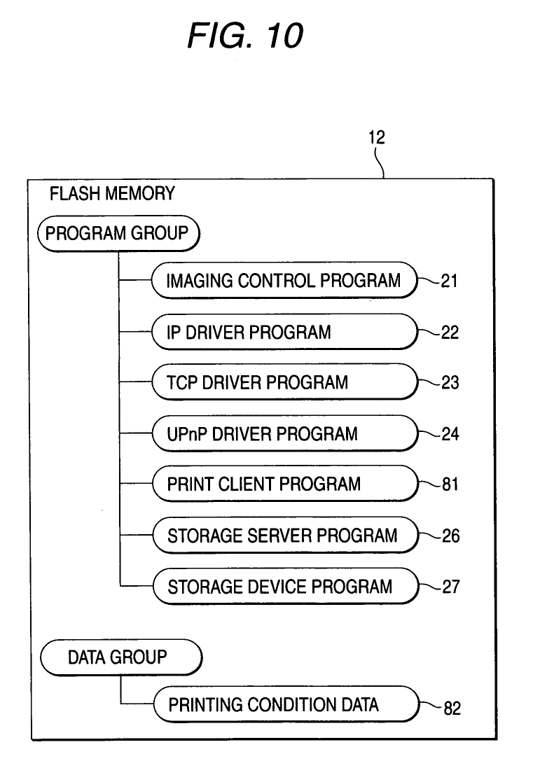

FIG. 10 is a view showing stored contents of the flash memory 12 of the DSC 1 according to a second embodiment of the present invention. A program group and a data group are stored in the flash memory 12 of the DSC 1. The program group of the flash memory 12 includes an imaging control program 21, an IP driver program 42, a TCP driver program 43, a UPnP driver program 44, a print client program 81, a storage server program 26, and a storage device program 27. The data group of the flash memory 12 includes printing condition data 82.

The printing condition data 82 are data for use in the direct printing to be performed by the DSC 1 and the printer 2. For instance, conditions for specifying the size or type of paper, printing/nonprinting of a date, printing/nonprinting of a file name, specification of print quality, specification of a layout such as index printing, specification of the number of copies, and specification of either the image data file 28 or the DPOF file are set in the printing condition data 82.

The print client program 81 is executed by the central processing unit 31, thereby realizing a print client which exchanges a request or response pertaining to control of a progress in printing operation or to printing operation. The print client performs direct printing operation complying with the printing condition data 82.

The programs of the DSC 1 other than the print client program 81 exhibit the same functions as do the programs given the same names in the first embodiment; the same reference numerals are assigned to these programs; and their explanations are omitted. Further, the hardware configuration of the DSC 1 of the second embodiment and the configuration of the direct printing system other than the DSC 1 (i.e., the printer 2 and the wireless network 3) are the same as the hardware configuration of the counterpart DSC 1 and the configuration of the counterpart direct printing system in the first embodiment. The same designations and reference symbols are used, and their illustrations and explanations are omitted.

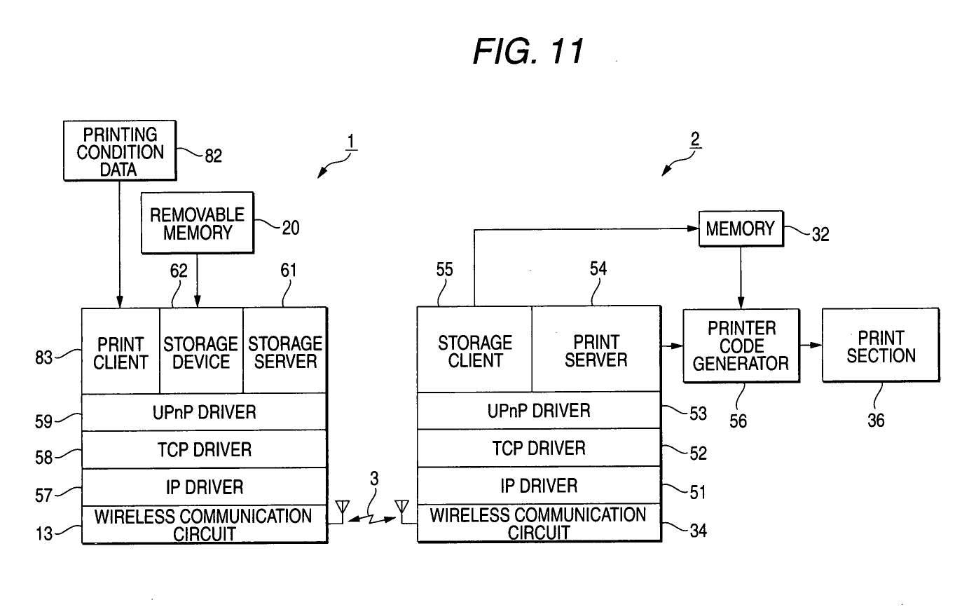

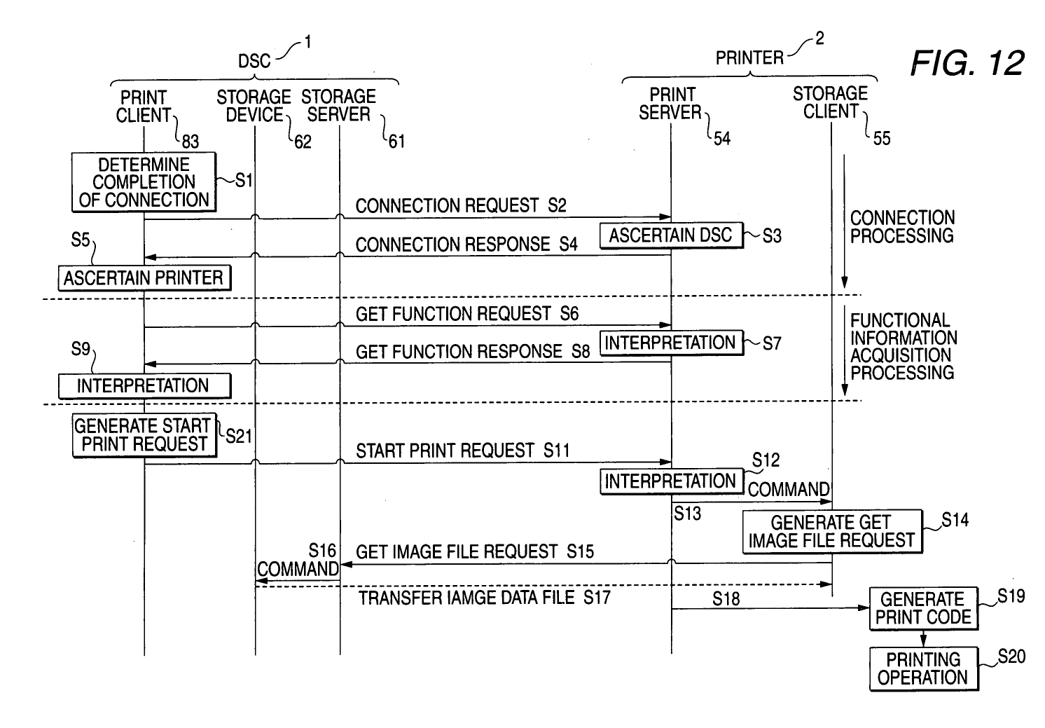

Operation of the direct printing system having the above-described configuration will now be described. FIG. 11 is a view showing the stacked structure of a communication protocol for use in direct printing operation realized by the direct printing system of the second embodiment. The stacked structure of the printer 2 is identical with that of the first embodiment. FIG. 12 is a view showing a direct printing operation sequence to be performed between the DSC 1 and the printer 2, both being shown in FIG. 11.

In the DSC 1 of the second embodiment, a print client 83 which is to serve as an output starter, the storage server 61, and the storage device 62 are ranked higher than the UPnP driver 59.

In the second embodiment, when the connection operation has been completed as in the case of the first embodiment, the print client 83 of the DSC 1 and/or the print server 54 of the printer 2 automatically start direct printing operation.

In the direct printing operation sequence, the print client 83 of the DSC 1 and the print server 54 of the printer 2 sequentially perform connection processing (steps S1 to S5) and functional information acquisition processing (steps S6 to S9).

Subsequently, on the basis of the printing capability of the printer 2, the print client 83 automatically generates a start print request for printing images of the image data files 28 stored in the removable memory 20 (step S21). At this time, the print client 83 of the second embodiment generates a start print request of the conditions specified by the print condition data 82.

In relation to the printing condition data 82, it is better to store the printing conditions set at the first startup of the print client 83 into the flash memory 12. Specifically, the print client 83 causes the display device 18 to display selected items of the printing conditions acquired when first started up. Accordingly, on the basis of the selection information obtained from the input device 19 in accordance with the user's operation, printing conditions pertaining to the selected item are stored into the flash memory 12 as the printing condition data 82.

The print client 83 of the DSC 1 transmits the generated start print request to the print server 54 (step S11). The print server 54 of the printer 2 interprets specifics of the print command of the start print request (step S12); causes the storage client 55 to acquire the image data file 28 required for printing (steps S13 to S17); and sends a printing operation command to the print code generator 56 (step S18). The print code generator 56 generates a printer code (step S19), and outputs the thus-generated printer code to the print section 36 via the I/O port 33. The print section 36 executes printing operation in accordance with the printer code (step S20). As a result, the printer 2 outputs a printed material complying with the contents of the printing condition data 82.

As mentioned above, in the second embodiment, the printer 2 can be caused to execute the direct printing complying with the printing conditions previously set by the printing condition data 82. Therefore, the user is not required to set printing conditions every printing operation; moreover, the user can cause the printer 2 to perform desired printing.

In the second embodiment, the printing condition data 82 are stored in the DSC 1, and the print client 83 of the DSC 1 generates a start print request complying with the printing conditions. In addition to this, it may also be possible that the printer 2 is caused to store the printing condition data 82 and that the print server 54 of the printer 2 prints only a request satisfying the printing conditions among the start print requests.

In the second embodiment, the flash memory 12 of the DSC 1 is caused to store the printing condition data 82, and the print client 83 generates the start print request by utilization of the printing condition data 82. Besides, it may also be possible that the print client 83 utilizes the printing conditions set in the DPOF data stored in the removable memory 20.

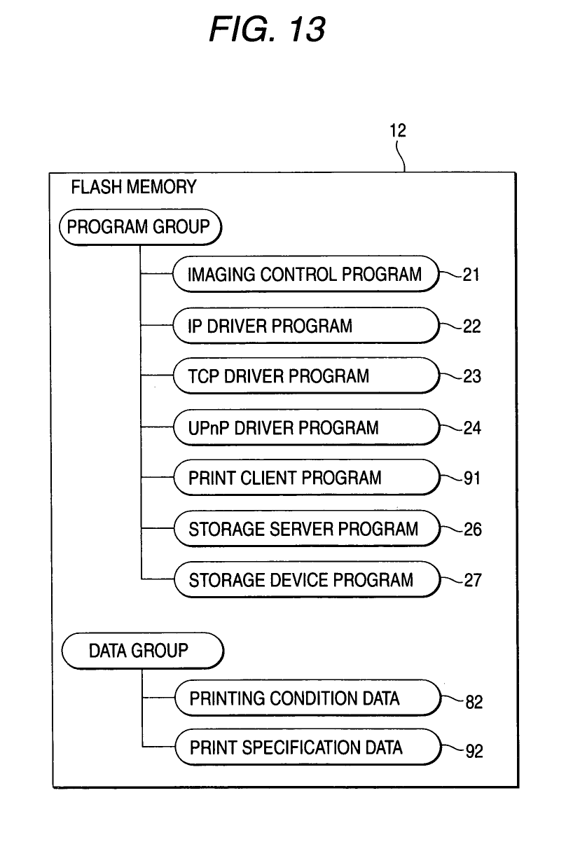

FIG. 13 is a view showing stored contents of the flash memory 12 of the DSC 1 according to a third embodiment of the present invention. A program group and a data group are stored in the flash memory 12 of the DSC 1. The program group of the flash memory 12 comprises the imaging control program 21, the IP driver program 22, the TCP driver program 23, the UPnP driver program 24, a print client program 91, the storage server program 26, and the storage device program 27. The data group of the flash memory 12 includes the storage device program 27. The data group of the flash memory 12 includes the printing condition data 82 and print specification data 92.

The print specification data 92 are data used for specifying the printer 2 which effects direct printing in conjunction with the DSC 1. Data which can be utilized as the print specification data 92 include, e.g., vendor information about the printer 2, a model name, a model, and a MAC address.

The print client program 91 is executed by the central processing unit 31, thereby realizing a print client which exchanges a request or response pertaining to control of a progress in printing operation or to printing operation. The print client performs direct printing operation complying with the printing condition data 82 in conjunction with the printer 2 specified by the printer specification data 92.

The programs of the DSC 1 other than the print client program 91 exhibit the same functions as do the programs given the same names in the first embodiment; the same reference numerals are assigned to these programs; and their explanations are omitted. The printing condition data 82 are the same as the data given the same name in the second embodiment; the same reference numeral is assigned to the data; and its explanation is omitted. Further, the hardware configuration of the DSC 1 of the third embodiment and the configuration of the direct printing system other than the DSC 1 (i.e., the printer 2 and the wireless network 3) are the same as the hardware configuration of the counterpart DSC 1 and the configuration of the counterpart direct printing system in the first embodiment. The same designations and reference symbols are used, and their illustrations and explanations are omitted.

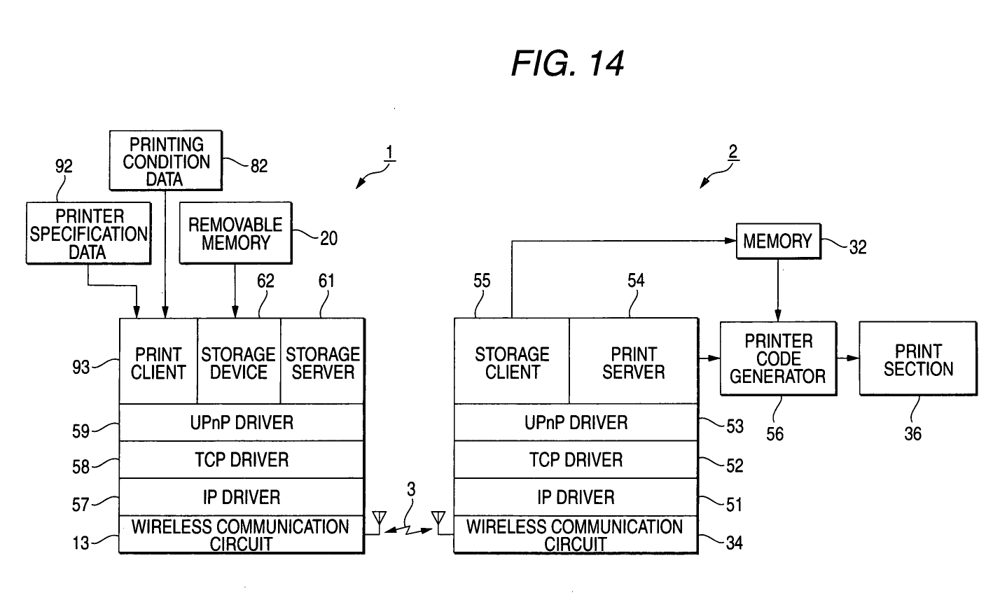

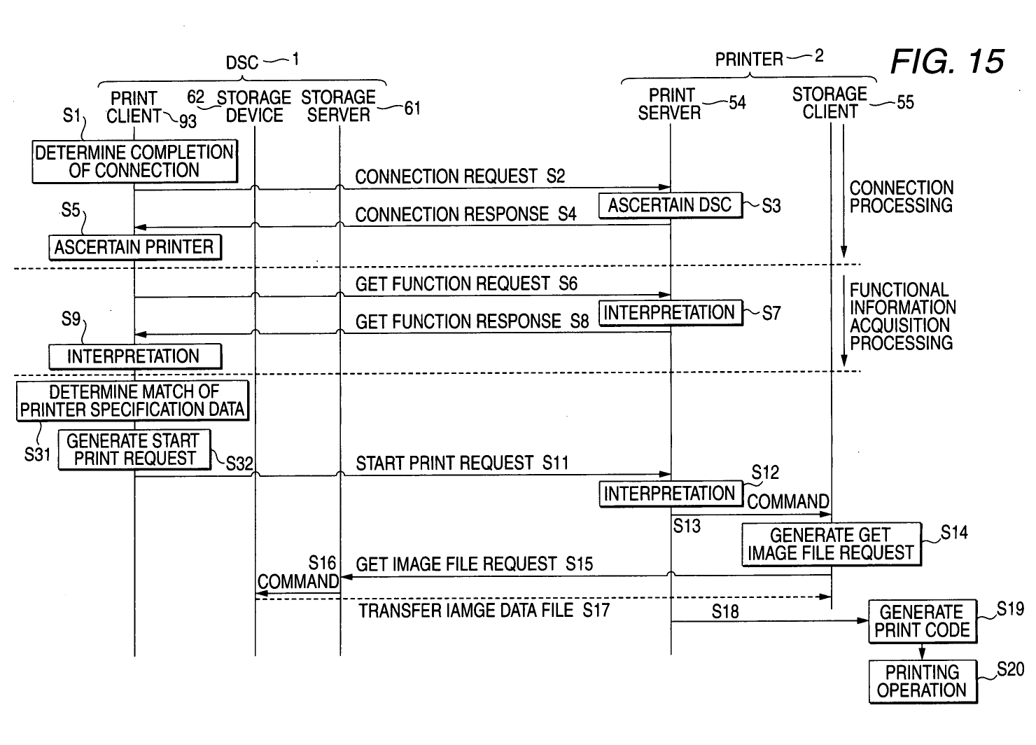

Operation of the direct printing system having the above-described configuration will now be described. FIG. 14 is a view showing the stacked structure of a communication protocol for use in direct printing operation realized by the direct printing system of the third embodiment. The stacked structure of the printer 2 is identical with that of the first embodiment. FIG. 15 is a view showing a direct printing operation sequence to be performed between the DSC 1 and the printer 2, both being shown in FIG. 14.

In the DSC 1 of the third embodiment, a print client 93 which is to serve as an output starter, the storage server 61, and the storage device 62 are ranked higher than the UPnP driver.

In the third embodiment, when the connection operation has been completed as in the case of the first embodiment, the IP address of the DSC 1 and that of the printer 2 are determined. Subsequently, the print client 93 of the DSC 1 and/or the print server 54 of the printer 2 automatically start direct printing operation.

In the direct printing operation sequence, the print client 93 of the DSC 1 and the print server 54 of the printer 2 sequentially perform connection processing (steps S1 to S5) and functional information acquisition processing (steps S6 to S9).

Subsequently, the printer client 93 determines whether or not the information about the printer 2 acquired through the functional information acquisition processing matches the specification information about the printer 2 included in the printer specification data 92 (step S31). When the information about the printing capability of the printer 2 does not match the printer specification data 92, the direct printing operation is aborted. When no match is found between the information and the data, it may also be possible that the print client 93 causes the display device 18 to display whether or not to continue the direct printing operation and the direct printing operation is continuously performed on the basis of approval information acquired by way of the input device 19 in accordance with the user's operation.

When the information about the printer 2 matches the printer specification data 92, the print client 93 automatically generates a start print request for printing images of the image data file 28 stored in the removable memory 20 in accordance with the conditions specified by the print condition data 82 (step S32).

In relation to the printing condition data 92, it is better to store the printing conditions set at the first startup of the print client 93 into the flash memory 12. Specifically, the print client 93 stores in the flash memory 12 as printer specification data 92 a portion or all of the information pertaining to the printing capability of the printer 2 that is connected upon initial startup.

The print client 93 of the DSC 1 transmits the generated start print request to the print server 54 (step S11). The print server 54 of the printer 2 interprets specifics of the print command of the start print request (step S12); causes the storage client 55 to acquire the image data file 28 required for printing (steps S13 to S17); and sends a printing operation command to the print code generator 56 (step S18). The print code generator 56 generates a printer code, and outputs the thus-generated printer code to the print section 36 via the I/O port 33 (step S19). The print section 36 executes printing operation in accordance with the printer code (step S20). As a result, the printer 2 specified by the printer specification data 92 outputs a printed material complying with the contents of the printing condition data 82.

As mentioned above, in the third embodiment, the printer 2 which is to perform automatic printing is set in advance by the printer specification data 92, whereby execution of automatic direct printing can be managed. Further, a printer other than the previously-set printer 2 can be prevented from performing unnecessary printing operation. Moreover, the previously-set printer 2 can automatically perform direct printing.

In the third embodiment, the flash memory 12 of the DSC 1 is caused to store the printer specification data 92, and the print client 93 of the DSC 1 determines the printer 2 and transmits the start print request solely to the printer 2 specified by the printer specification data 92.

In the third embodiment, a determination can be prohibited from being made as to whether or not a match exists between the printer specification data 92 and the information about the printer 2; namely, automatic generation of a start print request can be allowed/prohibited according to a connected device. Besides, for instance, automatic printing enable/disable data are stored in the flash memory 12 of the DSC 1 and/or the memory 32 of the printer 2. Only when allowance is granted by the automatic printing enable/disable data, the DSC 1 may be allowed to automatically generate a start print request, or the printer 2 may be allowed to perform printing according to the start print request. As a result, when automatic printing is not allowed, the printer 2 can be prevented from performing unnecessary printing. In addition, when settings are made to allow automatic printing, the printer 2 can be caused to automatically perform printing.

In the third embodiment, the printer specification data 92 are stored in the DSC 1, and the print client 93 of the DSC 1 determines whether or not the printer 2 on the other end is appropriate. In addition to this, it may also be possible that DSC specification data are stored in the printer 2 and that the print server 54 of the printer 2 determines whether or not the DSC 1 on the other end is appropriate. When the DSC 1 is determined to be inappropriate, the essential requirement for the print server 54 is to perform automatic direct printing on the basis of a start print request.

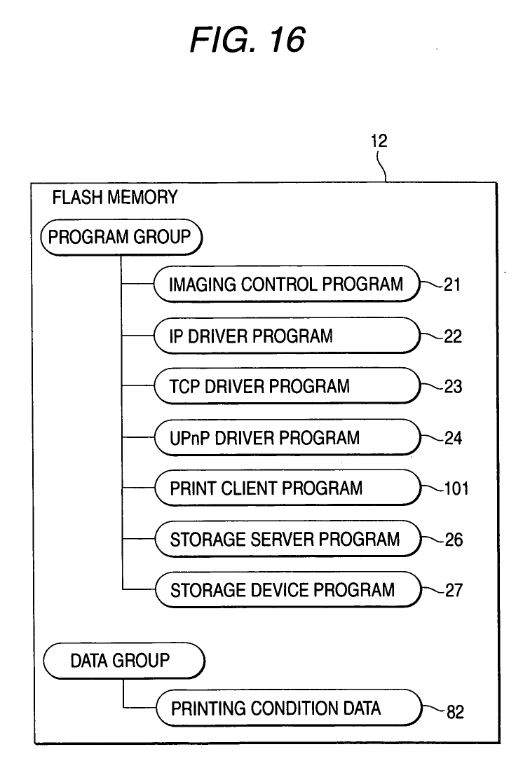

FIG. 16 is a view showing stored contents of the flash memory 12 of the DSC 1 according to a fourth embodiment of the present invention. A program group and a data group are stored in the flash memory 12 of the DSC 1. The program group of the flash memory 12 includes the imaging control program 21, the IP driver program 22, the TCP driver program 23, the UPnP driver program 24, a print client program 101, the storage server program 26, and the storage device program 27. The data group of the flash memory 12 includes the printing condition data 82.

The print client program 101 is executed by the central processing unit 31, thereby realizing a print client which exchanges a request or response pertaining to control of a progress in printing operation or to printing operation. The print client performs direct printing operation complying with the printing condition data 82 in conjunction with the printer 2 specified by the printer specification data 92.

The programs of the DSC 1 other than the print client program 101 exhibit the same functions as do the programs given the same names in the first embodiment; the same reference numerals are assigned to these programs; and their explanations are omitted. The printing condition data 82 are the same as the data given the same name in the second embodiment; the same reference numeral is assigned to the data; and its explanation is omitted. Further, the hardware configuration of the DSC 1 of the fourth embodiment and the configuration of the direct printing system other than the DSC 1 (i.e., the printer 2 and the wireless network 3) are the same as the hardware configuration of the counterpart DSC 1 and the configuration of the counterpart direct printing system in the first embodiment. The same designations and reference symbols are used, and their illustrations and explanations are omitted.

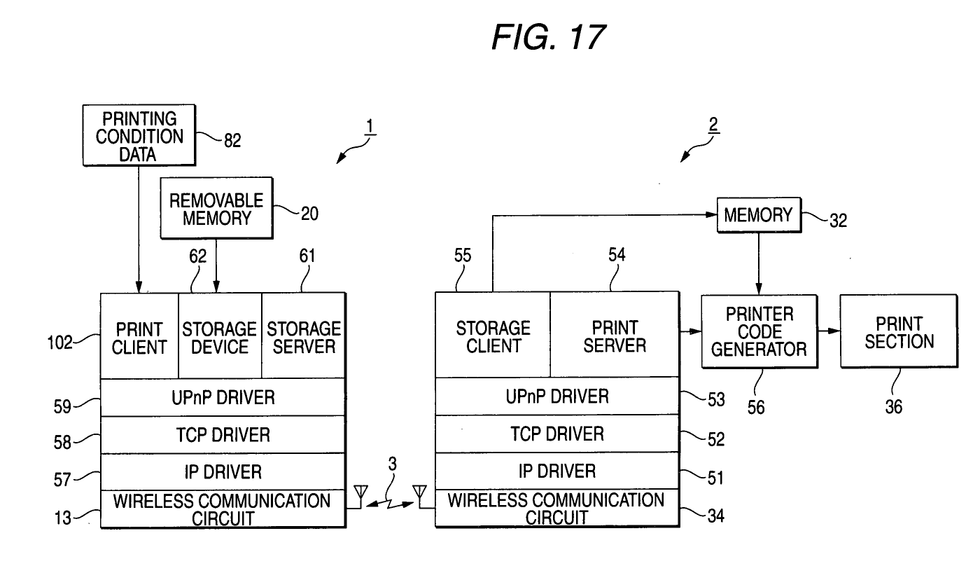

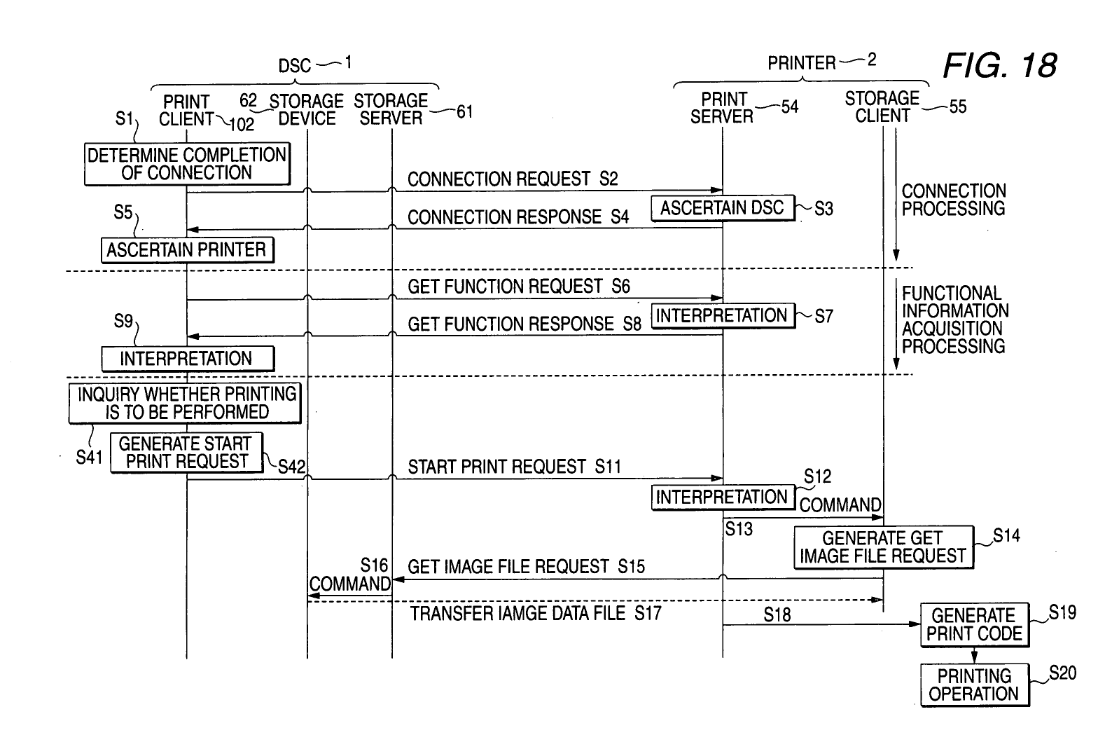

Operation of the direct printing system having the above-described configuration will now be described. FIG. 17 is a view showing the stacked structure of a communication protocol for use in direct printing operation realized by the direct printing system of the fourth embodiment. The stacked structure of the printer 2 is identical with that of the first embodiment. FIG. 18 is a view showing a direct printing operation sequence to be performed between the DSC 1 and the printer 2, both being shown in FIG. 17.

In the DSC 1 of the fourth embodiment, a print client 102 which is to serve as an output starter, the storage server 61, and the storage device 62 are ranked higher than the UPnP driver 59.

In the fourth embodiment, when the connection operation has been completed as in the case of the first embodiment, the print client 102 of the DSC 1 and/or the print server 54 of the printer 2 automatically start direct printing operation.

In the direct printing operation sequence, the print client 102 of the DSC 1 and the print server 54 of the printer 2 sequentially perform connection processing (steps S1 to S5) and functional information acquisition processing (steps S6 to S9).

Subsequently, the print client 102 causes the display device 18 to display a screen for inquiring whether or not the direct printing complying with the previously-set printing condition data 82 is to be performed (step S41). When input information indicating that direction printing is not preformed is acquired from the input device 19 in accordance with the user's operation, the print client 102 aborts the direct printing.

When input information indicating that direct printing is to be performed is acquired from the input device 19, the print client 102 automatically generates a start print request for printing images of the image data file 28 stored in the removable memory 20 in accordance with the conditions specified by the printing condition data 82 (step S42).

The print client 102 of the DSC 1 transmits the generated start print request to the print server 54 (step S11). The print server 54 of the printer 2 interprets specifics of the print command of the start print request (step S12); causes the storage client 55 to acquire the image data file 28 required for printing (steps S13 to S17); and sends a printing operation command to the print code generator 56 (step S18). The print code generator 56 generates a printer code, and outputs the thus-generated printer code to the print section 36 via the I/O port 33 (step S19). The print section 36 executes printing operation in accordance with the printer code (step S20). As a result, the printer 2 outputs a printed material complying with the contents of the printing condition data 82.

As mentioned above, in the fourth embodiment, the user is caused to instruct whether or not automatic direct printing is to be performed, whereby execution of automatic direct printing can be managed. Specifically, automatic printing can be prohibited by the user's operation. Moreover, the printer 2 can be caused to automatically perform direct printing by solely permitting automatic printing.

In the fourth embodiment, after the operation for acquiring functional information has been completed, the print client 102 of the DSC 1 makes an inquiry about whether or not direct printing is to be performed. On the basis of input information corresponding to the result of the inquiry, the print client generates a start print request. In addition, it may also be possible that the print client 102 of the DSC 1 inquires whether or not direct printing is to be performed at a start time of direct printing operation (step S1) or inquires, in a step subsequent to step S12, whether or not direct printing is to be performed on the basis of a request for the print server 54 of the printer 2 that has received the start print request.

In the fourth embodiment, the print client 102 of the DSC 1 spontaneously prompts the user to ascertain whether or not direct printing is to be performed. In addition, it may also be possible that, when the print server 54 of the printer 2 has received the start print request or the like, an acknowledgment request is transmitted to the DSC 1 and that the print client 102 prompts the user to ascertain whether or not direct printing is to be performed, on the basis of the acknowledgment request.

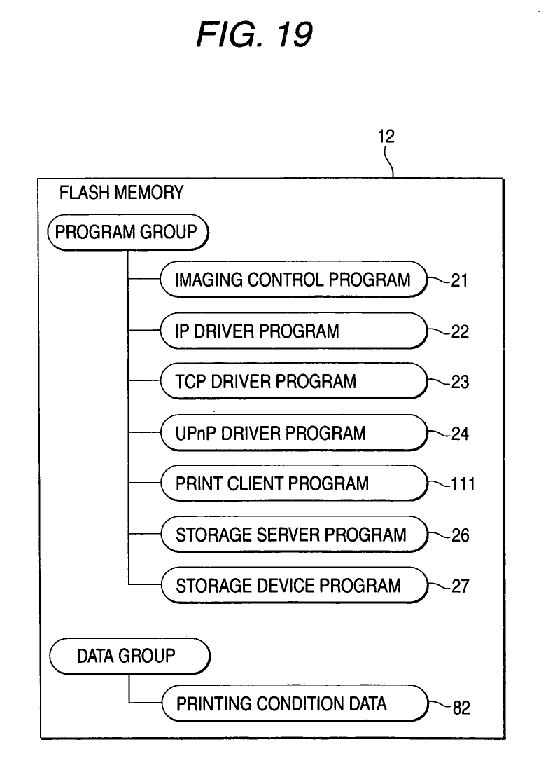

FIG. 19 is a view showing stored contents of the flash memory 12 of the DSC 1 according to a fifth embodiment of the present invention. A program group and a data group are stored in the flash memory 12 of the DSC 1. The program group of the flash memory 12 includes the imaging control program 21, the IP driver program 22, the TCP driver program 23, the UPnP driver program 24, a print client program 111, the storage server program 26, and the storage device program 27. The data group of the flash memory 12 includes the printing condition data 82.

The print client program 111 is executed by the central processing unit 31, thereby realizing a print client which exchanges a request or response pertaining to control of progress in printing operation or to printing operation. The print client performs direct printing operation complying with the printing condition data 82 in accordance with the printing condition data 82.

The programs of the DSC 1 other than the print client program 111 exhibit the same functions as do the programs given the same names in the first embodiment; the same reference numerals are assigned to these programs; and their explanations are omitted. The printing condition data 82 are the same as the data given the same name in the second embodiment; the same reference numeral is assigned to the data; and its explanation is omitted. Further, the hardware configuration of the DSC 1 of the fifth embodiment is the same as the hardware configuration of the counterpart DSC 1 in the first embodiment. The same designations and reference symbols are used, and their illustrations and explanations are omitted.

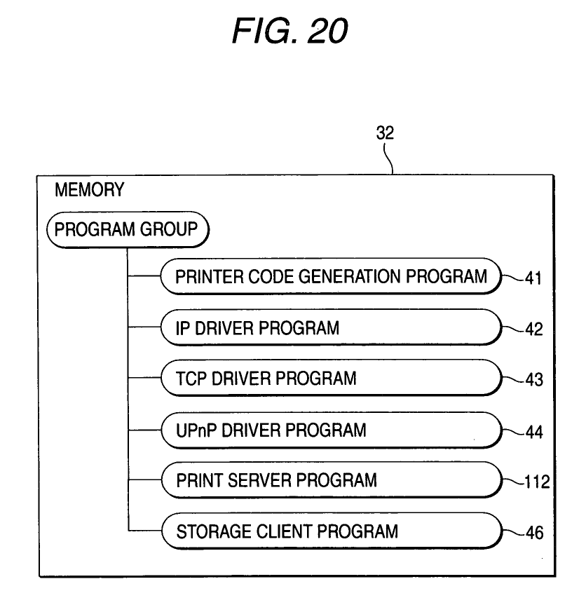

FIG. 20 is a view showing stored contents of the flash memory 12 of the DSC 1 according to the fifth embodiment of the present invention. A program group is stored in the memory 32. The program group of the memory 32 includes the printer code generation program 41, the IP driver program 42, the TCP driver program 43, the UPnP driver program 44, a print server program 112, and the storage client program 46.

The print server program 112 is executed by the central processing unit 31, thereby realizing a print client which exchanges a request or response pertaining to control of a progress in printing operation or to printing operation.

The programs of the printer 2 other than the print server program 112 exhibit the same functions as do the programs given the same names in the first embodiment; the same reference numerals are assigned to these programs; and their explanations are omitted. Further, the hardware configuration of the printer 2 of the fifth embodiment is the same as the hardware configuration of the counterpart printer in the first embodiment. The same designations and reference symbols are used, and their illustrations and explanations are omitted. The wireless network 3 of the fifth embodiment is the same as the counterpart wireless network of the first embodiment, and the same designation and reference symbol are used, and its illustration and explanation are omitted.

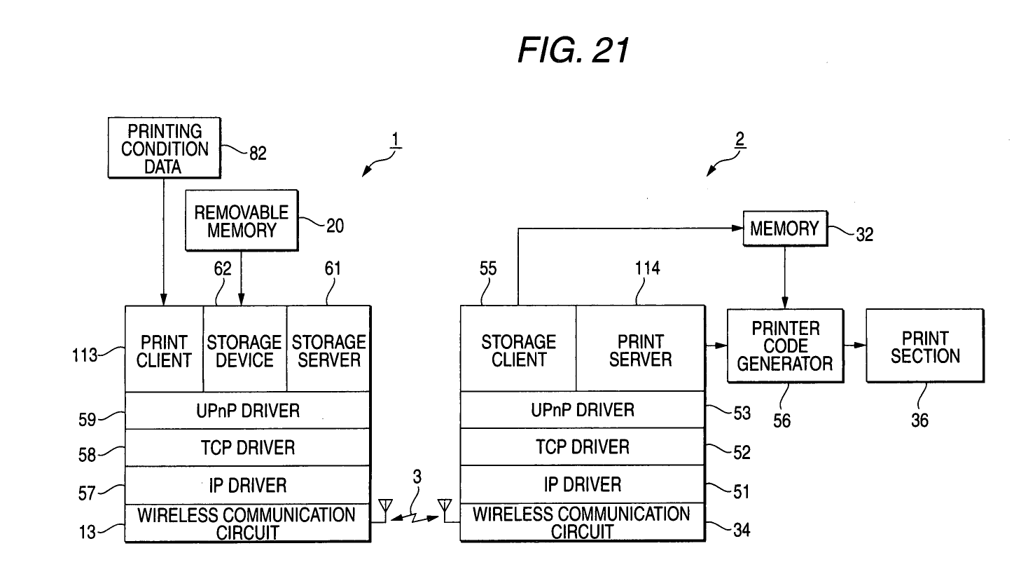

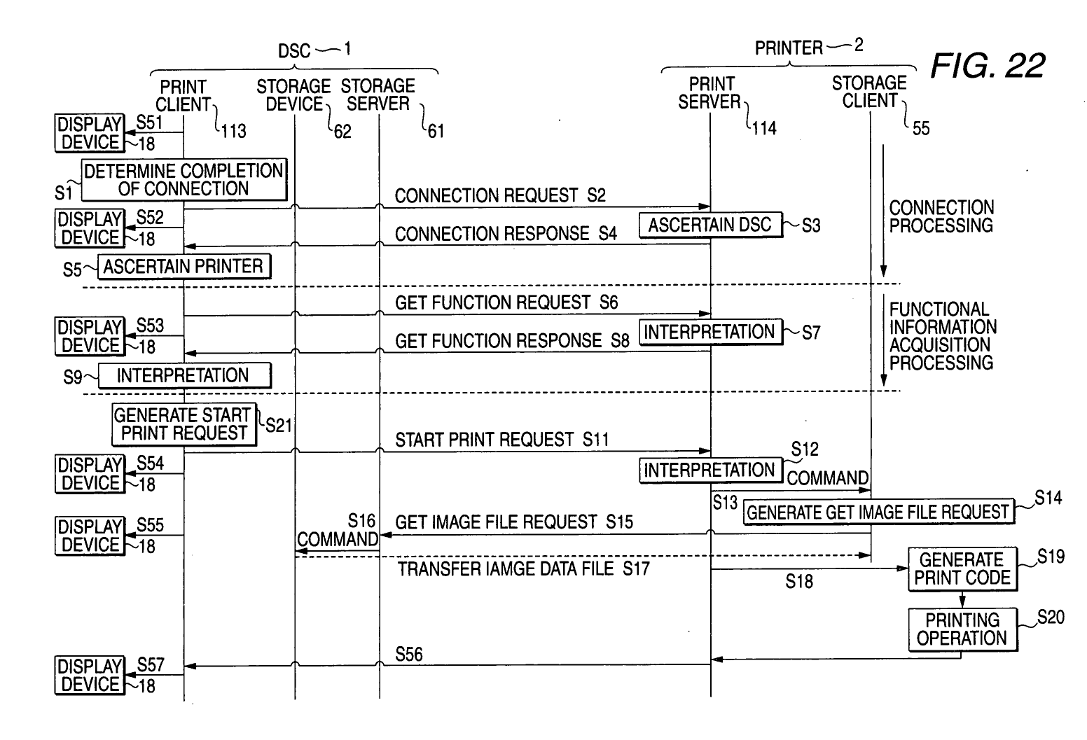

Operation of the direct printing system having the above-described configuration will now be described. FIG. 21 is a view showing the stacked structure of a communication protocol for use in direct printing operation realized by the direct printing system of the fifth embodiment. FIG. 22 is a view showing a direct printing operation sequence to be performed between the DSC 1 and the printer 2, both being shown in FIG. 21.

In the DSC 1 of the fifth embodiment, a print client 113 which is to serve as an output starter, the storage server 61, and the storage device 62 are ranked higher than the UPnP driver 59.

In the printer 2 of the fifth embodiment, the print server 114 and the storage client 55 are ranked higher than the UPnP driver 53.

In the fifth embodiment, when the connection operation has been completed as in the case of the first embodiment, the print client 113 of the DSC 1 and/or a print server 114 of the printer 2 automatically start direct printing operation. The print client 113 of the DSC 1 causes the display device 18 to display an indication that the print client has become communicable; namely, an indication that automatic connection to the printer 2 having been completed (step S51).

In the direct printing operation sequence, the print client 113 of the DSC 1 and the print server 114 of the printer 2 first sequentially perform connection processing (steps S1 to S5) and functional information acquisition processing (steps S6 to S9). During a period from when the connection request is transmitted until when the printer 2 is ascertained, the print client 113 of the DSC 1 causes the display device 18 to display an indication that connection processing is in operation (step S52). During a period from when the get function request is transmitted until completion of interpretation of information about the printing capability of the printer 2, the print client 113 of the DSC 1 causes the display device 18 to display an indication that functional information acquisition is in operation (step S53).

Subsequently, the print client 113 automatically generates a start print request including the conditions specified by the print condition data 82 (step S21), and transmits the thus-generated start print request to the print server 114 (step S11). Further, the print client 113 causes the display device 18 to display an indication that direct printing is in operation (step S54).

The print server 114 of the printer 2 interprets specifics of the print command of the start print request (step S12); causes the storage client 55 to acquire the image data file 28 required to effect printing complying with the print command (steps S13 to S17); and commands the print code generator 56 to perform printing operation (step S18). In the meantime, when the image data file 28 has been acquired, the print client 113 causes the display device 18 to display an indication that the printer 2 has acquired image data (step S55). In relation to display processing of the print client 113, the print client 113 monitors an access to the storage device 62, and the print client 113 spontaneously effects display when an access is made. Alternatively, the print client 113 may effect display on the basis of a report from the print server 114, the storage server 61, or the storage device 62.

The print code generator 56 generates a printer code, and outputs the thus-generated printer code to the print section 36 by way of the I/O port 33 (step S19). The print section 36 performs printing operation in accordance with the printer code (step S20). As a result, the printer 2 outputs a printed material complying with the specifics of the print condition data 82.

When connection operation is completed, the print server 114 transmits to the print client 113 a print completion report which reports completion of the printing operation and is described in an XML format (step S56). Upon receipt of the print completion report, the print client 113 causes the display device 18 to display an indication that printing has been completed; i.e., automatic completion of direct printing (step S57). The print server 114 may perform a printing operation completion determination on the basis of completion of actual printing operation of the print section 36 or completion of an output to the print section 36 of the printer code.

As mentioned above, in the fifth embodiment, the display device 18 displays the progress of connection processing or printing operation. Hence, the user can grasp the course of processing and completion of processing.

In the fifth embodiment, in relation to a connection between the DSC 1 and the printer 2, the display device 18 displays only automatic completion of the connection (step S51). A message indicating that connection is in operation may also be displayed in stages during the course of connection processing.

In the fifth embodiment, in relation to the printing operation effected between the DSC 1 and the printer 2, a message indicating that printing is in operation is displayed in stages during the course of printing operation (steps S52 to S57). However, it may also be possible that the display device 18 displays only completion of the printing operation (step S57).

In the fifth embodiment, a report to the user during the course of automatic performance of direct printing is spontaneously issued by the print client 113 of the DSC 1. In addition, on the basis of a report about a job status or the status of equipment from the print server 114 of the printer 2 to the print client 113 of the DSC 1, the print client 113 may cause the display device 18 to display information about the report. Moreover, the report may also be generated by the storage server 61 or the storage device 62.

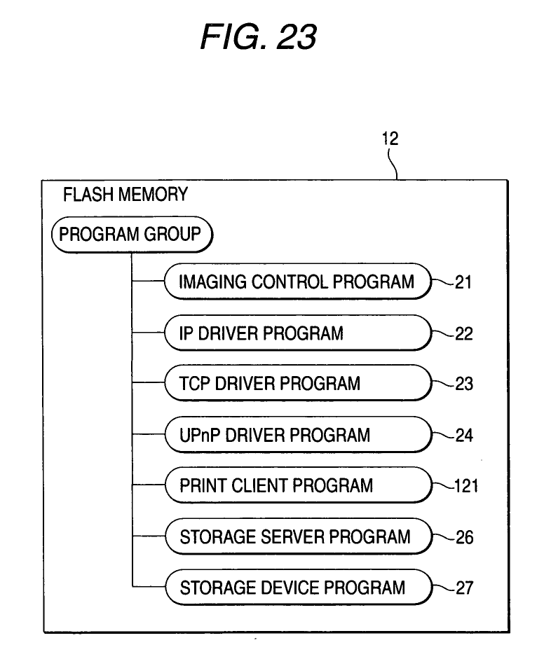

FIG. 23 is a view showing stored contents of the flash memory 12 of the DSC 1 according to the second embodiment of the present invention. A program group and a data group are stored in the flash memory 12 of the DSC 1. The program group of the flash memory 12 includes the imaging control program 21, the IP driver program 22, the TCP driver program 23, the UPnP driver program 24, a print client program 121, the storage server program 26, and the storage device program 27. The programs of the DSC 1 other than the print client program 121 exhibit the same functions as do the programs given the same names in the first embodiment; the same reference numerals are assigned to these programs; and their explanations are omitted.

The print client program 121 is executed by the central processing unit 31, thereby realizing a print client which exchanges a request or response pertaining to control of a progress in printing operation or to printing operation. The print client performs direct printing operation in accordance with the printing condition data 82.

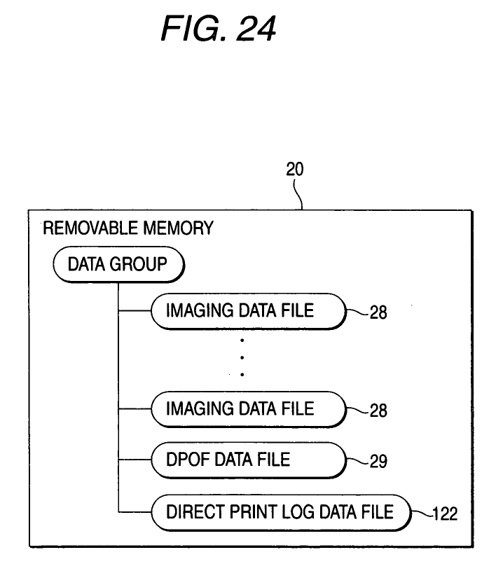

FIG. 24 is a view showing stored contents of the removable memory 20 of the DSC 1 according to the second embodiment of the present invention. A data group is stored in the removable memory 20. The data group of the removable memory 20 includes the plurality of image data files 28, the DPOF data file 29, and a direct print log data file 122. The data of the removable memory 20 other than the direct print log data file 122 exhibit the same functions as do the data given the same names in the first embodiment; the same reference numerals are assigned to these programs; and their explanations are omitted.

The direct print log data file 122 is a file for recording a log (print history) of direct printing of the image data in the removable memory 20. Specifically, file information about the image data files 28 that have been subjected to direct printing (file names, file IDs, or the like) are stored in the direct print log data file 122.

Further, the hardware configuration of the DSC 1 of the sixth embodiment and the configuration of the direct printing system other than the DSC 1 (i.e., the printer 2 and the wireless network 3) are the same as the hardware configuration of the counterpart DSC 1 and the configuration of the counterpart direct printing system in the first embodiment. The same designations and reference symbols are used, and their illustrations and explanations are omitted.

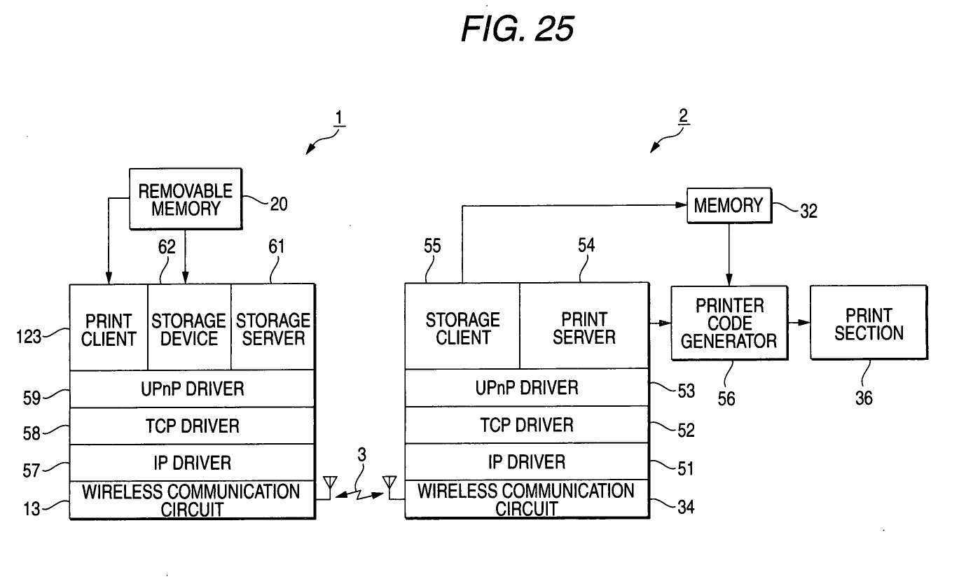

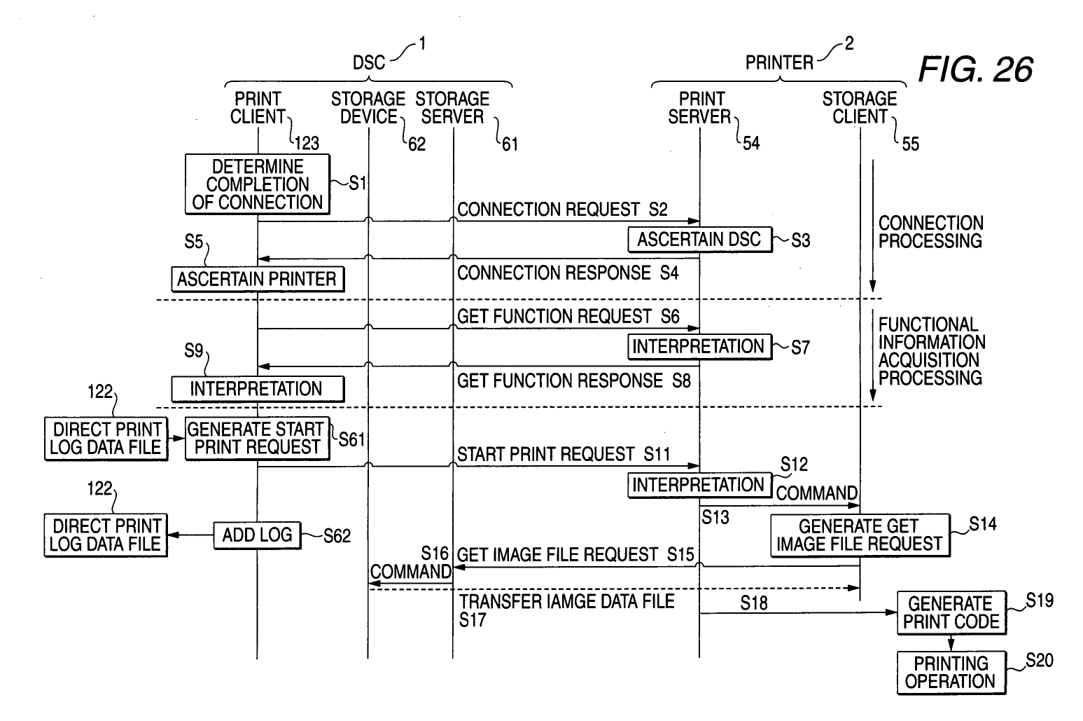

Operation of the direct printing system having the above-described configuration will now be described. FIG. 25 is a view showing the stacked structure of a communication protocol for use in direct printing operation realized by the direct printing system of the sixth embodiment. The stacked structure of the printer 2 is identical with that of the first embodiment. FIG. 26 is a view showing a direct printing operation sequence to be performed between the DSC 1 and the printer 2, both being shown in FIG. 25.

In the DSC 1 of the sixth embodiment, a print client 123 which is to serve as an output starter, the storage server 61, and the storage device 62 are ranked higher than the UPnP driver 59.

In the sixth embodiment, when the connection operation has been completed as in the case of the first embodiment, the print client 123 of the DSC 1 and/or the print server 54 of the printer 2 automatically start direct printing operation.

In the direct printing operation sequence, the print client 123 of the DSC 1 and the print server 54 of the printer 2 first sequentially perform connection processing (steps S1 to S5) and functional information acquisition processing (steps S6 to S9).

Subsequently, the print client 123 automatically generates a start print request for printing images of the image data file 28 stored in the removable memory 20, on the basis of information about the printing capability of the printer 2. At this time, the print client 123 of the sixth embodiment ascertains the log of the direct print log data file 122 and generates a start print request for printing all of the image data files 28 which are stored in the removable memory 20 and have not yet been subjected to direct printing (step S61).

The print client 123 of the DSC 1 transmits the generated start print request to the print server 114 (step S11). The print server 54 of the printer 2 interprets specifics of the print command of the start print request (step S12); causes the storage client 55 to acquire the image data file 28 required for printing (steps S13 to S17); and sends a printing operation command to the print code generator 56 (step S18). The print code generator 56 generates a printer code, and outputs the thus-generated printer code to the print section 36 via the I/O port 33 (step S19). The print section 36 executes printing operation in accordance with the printer code (step S20). As a result, the printer 2 outputs a printed material of images based on all of the image data files which are stored in the removable memory 20 and have not yet been printed.

Moreover, after having transmitted the generated start print request to the print server 54 (step S11), the print client 123 adds, to the direct print log data file 122, the file name of the image data file 28 which is the subject of a print command issued by the start print request (step S62). As a result, the images of the image data file 28 which are the subject of print commands during the current automatic direct printing are prevented from being printed in the next direct printing operation. Specifically, only images of the image data file added to the removable memory 20 after the current printing operation are printed during the next automatic direct printing operation.

As mentioned above, in the sixth embodiment, the printer 2 can be caused to automatically print only the images of the image data file 28 which have never been subjected to automatic direct printing. As a result, the images belonging to the same image data file 28 can be prevented from being printed a plurality of times.

In the sixth embodiment, the direct print log data file 122 is stored in the removable memory 20 of the DSC 1. However, the direct print log data file 122 may also be stored in the flash memory 12 of the DSC 1.

When the plurality of image data files 28 are stored in separate storages, it may also be possible that a plurality of files of the same file name are present in the plurality of storages. For example, such a situation arises when the plurality of removable memory devices 20 are used while being exchanged. Therefore, when a plurality of storages are used for storing the image data file 28, the print client 123 stores, in the direct print log data file 122, a time at which a file is generated, and EXIF data pertaining to the file, image data pertaining to or a hash value of the file (entire data) along with the file name of the image data file 28 which has been subjected to direct printing. The essential requirement is that, on the basis of a combination of pieces of information about the plurality of file, a determination should be made as to whether or not the respective image data files 28 are printed through automatic direct printing. As a result, even when the plurality of image data files 28 of the same file name are present, the file can be automatically subjected to direct printing only once.

In the sixth embodiment, automatic direct printing is performed by specifying the file name of the image data file 28. However, the print client 123 may perform automatic direct printing by specifying the DPOF data file 29. In this case, the print client 123 can delete the DPOF data file 29 after automatic direct printing, thereby preventing execution of automatic direct printing of the same DPO data file.

In the sixth embodiment, the direct print log data 122 is stored in the DSC 1, and the print client 123 of the DSC 1 generates a start print request for commanding printing of the image data files 28 which are not included in the log. In addition, the direct print data log 122 may also be stored in the printer 2, and the print server 54 of the printer 2 may be caused to print the image data files exclusive of the image data files 28 included in the direct print log data 122.

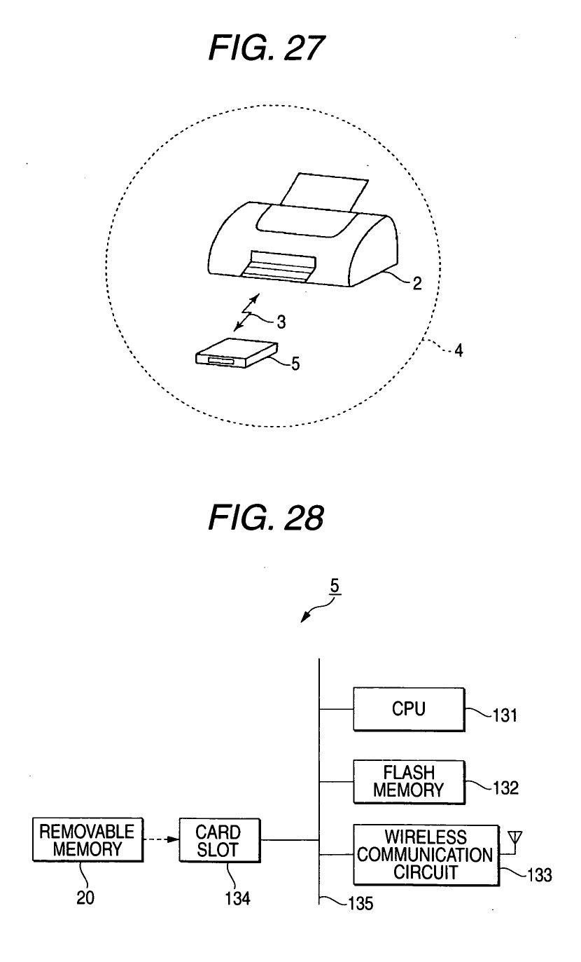

FIG. 27 is a block diagram showing a direct printing system according to a seventh embodiment of the present invention. The direct printing system has a card reader 5 which is to serve as an image supplying apparatus and the printer 2. The card reader 5 and the printer 2 are connected by the wireless network 3. The printer 2 and the wireless network 3 exhibit the same functions as do the elements given the same names in the first embodiment; the same reference numerals are assigned to them; and their explanations are omitted.

FIG. 28 is a block diagram showing the hardware configuration of the card reader 5 shown in FIG. 27. The card reader 5 comprises a central processing unit 131 which runs a program; a flash memory 132; a wireless communication circuit 133 connected to the wireless network 3; a card slot 134; and a bus 135 for interconnecting these elements. The removable memory 20, which is formed from semiconductor memory and serves as a storage or a recording medium, is removably inserted into the card slot 134.

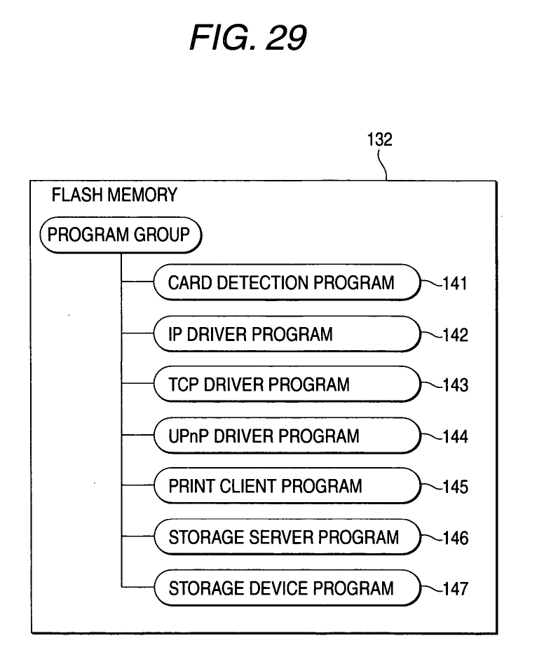

FIG. 29 is a view showing stored contents of flash memory 132 shown in FIG. 28. A program group is stored in the flash memory 132. The program group of the flash memory 132 comprises a card detection program 141, an IP driver program 142, a TCP driver program 143, a UPnP driver program 144, a print client program 145, a storage server program 146, and a storage device program 147. The programs of the card reader 5 other than the card detection program 141 exhibit the same functions as do the programs given the same names in the first embodiment, and their explanations are omitted.

The card detection program 141 is executed by the central processing unit 131, thereby realizing a card detector. The card detector detects insertion of the removable memory 20 in the card slot 134.

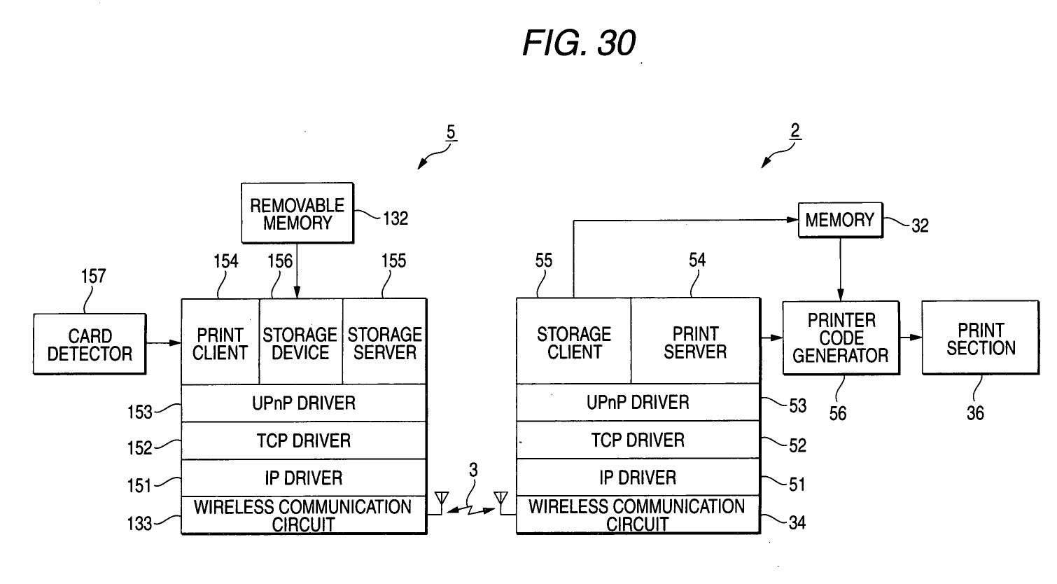

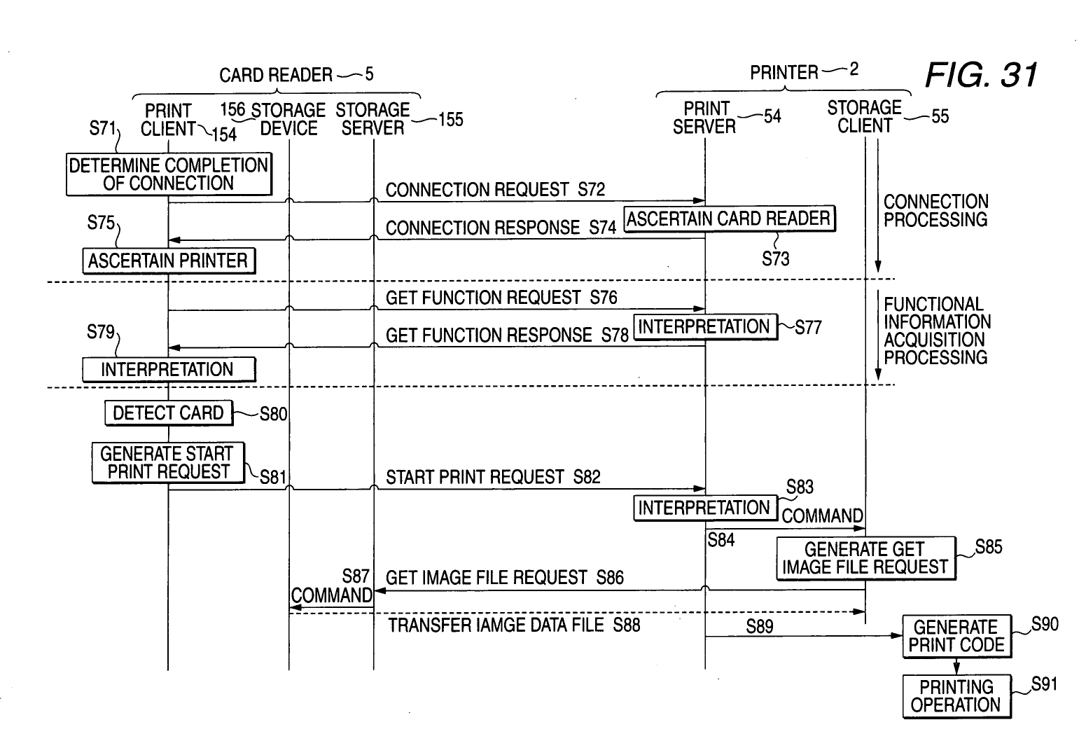

Operation of the direct printing system having the above-described configuration will now be described. FIG. 30 is a view showing the stacked structure of a communication protocol for use in direct printing operation realized by the direct printing system shown in FIG. 27. The stacked structure of the printer 2 is identical with that of the first embodiment. FIG. 31 is a view showing a direct printing operation sequence to be performed between the card reader 5 and the printer 2, both being shown in FIG. 30.

In the card reader 5, an IP driver 151, a TCP driver 152, and a UPnP driver 153 are ranked higher than the wireless communication circuit 133. A print client 154 which is to serve as an output starter, a storage server 155, and a storage device 156 are ranked higher than the UPnP driver 153. These drivers exhibit the same functions as do the drivers given the same names and functions realized by the DSC 1 in the first embodiment.

When the connection operation has been completed as in the case of the first embodiment, the print client 154 of the DSC 1 and/or the print server 54 of the printer 2 automatically start direct printing operation.

In the direct printing operation sequence, the print client 154 of the card reader 5 and the print server 54 of the printer 2 first sequentially perform connection processing (steps S71 to S75) and functional information acquisition processing (steps S76 to S79) as in the first embodiment.

Subsequently, the print client 154 of the card reader 5 ascertains whether or not a card detector 157 has detected insertion of the removable memory 20. When the card detector 157 has not detected insertion of the removable memory 20, the print client 154 waits detection of insertion of the removable memory (step S80).

When the card detector 157 has detected insertion of the removable memory 20, the print client 154 automatically generates a start print request for printing images of all of the image data files 28 stored in the removable memory 20, on the basis of information about the printing capability of the printer 2 acquired through functional information acquisition processing (step S81).

The print client 154 of the card reader 5 transmits the thus-generated start print request to the print server 54 (step S82). The print server 54 of the printer 2 interprets specifics of the print command of the start print request (step S83); causes the storage client 55 to acquire the image data file 28 required to perform printing complying with the print command (steps S84 to S88); and issues a print processing command to the print code generator 56 (step S89). The print code generator 56 generates a printer code, and outputs the thus-generated printer code to the print section 36 by way of the I/O port 33 (step S90). The print section 36 performs printing operation in accordance with the printer code (step S90). As a result, the printer 2 produces a printed material of images of all of the image data files 28 stored in the removable memory 20 inserted in the card reader 5.

As mentioned above, in the seventh embodiment, when the removable memory 20 is inserted into the card reader 5, direct printing is automatically initiated. Therefore, the user does not need to perform operation required to cause the card reader 5 or the printer 2 to perform direct printing. Consequently, the user is not required to perform complicate operation every time the printer 2 is caused to print an image of the image data file 28 of the removable memory 20.

In the seventh embodiment, a printed material of images of all of the image data files 28 stored in the removable memory 20 is produced. In addition, the direct printing system having the card reader 5 and the printer 2 may store the printing condition data 82 into the flash memory 132 of the card reader 5 and cause the printer 2 to subject to direct printing the images complying with the printing condition data 82; or may store the direct print log data into the removable memory 20 and cause the printer 2 to subject the images complying with the direct print log data to direct printing.

In the seventh embodiment, the print client 154 of the card reader 5 spontaneously detects insertion of the removable memory 20, and automatically starts direct printing on the basis of the result of detection. It may also be possible that the print server 54 of the printer 2 transmits a request for detecting insertion of the removable memory 20 and that the print client 154 detects insertion of the removable memory 20 on the basis of the request.

Although the above-described embodiments are preferred examples of the present invention, the present invention is not limited to these embodiments and is susceptible to various modifications or alterations.

For instance, in the above-described respective embodiments, the DSC 1 or the card reader 5 is used as an example of the image supplying apparatus. However, the image supplying apparatus is not limited to these devices and may be embodied as a portable cellular phone, a PDA, any of various media players, or the like. Further, in the respective embodiments, the printer 2 is used as an example of the image output apparatus. However, the image output apparatus is not limited to the printer and may also be embodied by a display device, such as a television set or a computer display, a projecting apparatus such as a projector, or the like. When the image output apparatus is embodied as a display device or a projector, the image data file is not limited to a stationary image but may be a motion picture.

In the respective embodiments, the DSC 1 and the printer 2 or the card reader 5 and the printer 2 are connected together by the wireless network 3. In addition to this, the DSC 1 and the printer 2 or the card reader 5 and the printer 2 may be connected together by a wire cable such as Ethernet (trademark). When a wire cable is used, connection of the DSC 1 to the printer 2 by the wire cable corresponds to the DSC 1 and the printer 2 entering the single wireless connection zone 4.

In the above-described respective embodiments, the removable memory 20 is used as storage or a recording medium. However, a medium or a circuit capable of effecting magnetic or optical storage or recording may also be used in place of the removable memory.

1. An image supplying apparatus, comprising:
a communicator;
a monitor, which receives an image data file and monitors whether an image output apparatus which outputs an image on the basis of the image data file is communicable with the communicator;
a communication connector, which connects the communicator to an image output apparatus when the monitor determines that the image output apparatus is communicable with the communicator; and
an output starter, which transmits an output command to the image output apparatus after completion of the connection with the image output apparatus, to thus cause the image output apparatus to output an image.

2. The image supplying apparatus as set forth in claim 1, wherein the output starter generates an output command in accordance with preset output conditions and transmits the output command to the image output apparatus.

3. The image supplying apparatus as set forth in claim 1, wherein the output starter generates the output command immediately after the completion of the connection in a case where a setting allowing an automatic output is effected in advance, and transmits the output command to the image output apparatus.

4. The image supplying apparatus as set forth in claim 1, wherein the output starter generates an output command only when the output starter is connected to an image output apparatus specified in advance, and transmits the output command to the image output apparatus.

5. The image supplying apparatus as set forth in claim 1, wherein:
the output starter makes an inquiry about whether an automatic output is required when the connection to the image output apparatus is completed; and
the output starter generates an output command when allowance of the automatic output is instructed, and transmits the output command to the image output apparatus.

6. The image supplying apparatus as set forth in claim 1, further comprising a recording medium storing an image data file,
wherein the output starter generates an output command which specifies all of image data files not having been used for outputting images among the image data files in the recording medium, and transmits the output command to the image output apparatus.

7. The image supplying apparatus as set forth in claim 1, wherein the output starter informs the user of at least one of: that the connection to the image output apparatus is being automatically performed; that the connection to the image output apparatus has been automatically performed; that image output is being automatically performed; and that image output has been automatically performed.

8. A direct output system, comprising an image output apparatus provided with a communicator adapted to be connected the communicator of the image supplying apparatus as set forth in claim 1.

9. An image supplying apparatus, comprising:
a slot, into which a storage storing an image data file is removably inserted;
a communicator, adapted to communicate with a communicator of an image output apparatus which receives the image data file and outputs an image on the basis of the image data file; and
an output starter, which transmits an output command to the image output apparatus when the storage is inserted into the slot and causes the image output apparatus to start outputting an image on the basis of the image data file stored in the storage.

10. A direct output system, comprising an image output apparatus provided with a communicator adapted to be connected the communicator of the image supplying apparatus as set forth in claim 9.

11. An image output method, comprising:
monitoring whether an image output apparatus is connectable with an image supplying apparatus which supplies an image data file;
connecting the image supplying apparatus and the image output apparatus when the image output apparatus and the image supplying apparatus are communicable with each other; and
transmitting an output command from the image supplying apparatus to the image output apparatus after completion of the connecting, thereby causing the image output apparatus to start producing an image output.
